(19) United States
(12) Patent Application Publication
(10) Pub. No.: US 2025/0029514 A1
(43) Pub. Date: Jan. 23, 2025

(54) Designing Learning Games that are Fun to Play

(71) Applicant: Kumaresan Ramanathan, Bangalore (IN)

(72) Inventor: Kumaresan Ramanathan, Bangalore (IN)

(21) Appl. No.: 18/811,857

(22) Filed: Aug. 22, 2024

(51) Int. Cl. G09B 19/00

(52) U.S. Cl. CPC G09B 19/0053

(57) ABSTRACT

Creating an enjoyable learning-game that teaches programming skills, starting from a non-learning-game. We include a code editor for the player to enter code. We include a controller for the code to control game-mechanics including the challenge, the player-actions, and the feedback. The player is incentivized to enter code that helps the player obtain a better score in the game. We include constraints to limit the capabilities of the player's code so that it cannot make the game too easy (and therefore boring) for the player. When players enter code to help them win the game, they are solving programming problems. Solving programming problems is a learning-experience. By including a code editor, a controller, and constraints, the non-learning-game is converted into an enjoyable learning-game that teaches coding skills.

### REFERENCE TO A “SEQUENCE LISTING”, A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Files attached to this application in .txt format contain computer program listings and are incorporated here by reference.

### PRIOR ART

The following USPTO publications are relevant prior art:
US-2014/0297035-A1
US-2019/0340952-A1
US-2021/0065578-A1
US-2022/0013035-A1
US-2022/0076587-A1
US-2022/0101750-A1

### BACKGROUND OF THE INVENTION

### Definition of a Game & Components in a Game

We will be discussing concepts in the field of games. Let's begin by defining what a game is for the purposes of this document. There are many ways to define what a game is. The definition that is presented here is meant to clarify the concepts explained in this document.

Consider the schematic in FIG. 1. A game is a machine 1020. A human player 1010 interacts with this machine to play a game. The diagram FIG. 1 illustrates a single player game, so the human player 1010 will henceforth be called “player1”. A game is usually designed so that interaction between the game 1020 and the human player 1010 is enjoyable for the player 1010.

A game 1020 is comprised of multiple parts. A game might have more parts than have been shown in FIG. 1, but for the purpose of this document, these are the parts we need to consider. A game 1020 contains challenge-means 1030 to provide player1 1010 with an interesting challenge or problem to solve. Player1 1010 uses the game's input peripherals 1090 (such as a game-controller, mouse or keyboard) to indicate how the player wishes to respond to the problem presented by the challenge-means 1030. The game 1020 contains player-action-means 1040 which obtains the choices of player1 1010 through the input peripherals 1090. The player-action-means 1040 converts the choices of player1 into changes that happen within the game 1020. The game 1020 contains feedback-means 1050 which provides player1 1010 with feedback on the consequences of the choices input into the player-action-means 1040.

So far, our definition of a game has been very abstract. Let's put everything together by considering a concrete example as shown in FIG. 2. FIG. 2 shows the display of a videogame. 3070 is the display within which game elements are shown. 3060 is an alien ship that is shown to be attacking. 3050 is the direction in which the alien-ship 3060 is traveling. 3020 is the hit-line. That is, 3020 is the target which the alien ship 3060 is trying to reach. The human player of this game is supposed to prevent the alien ship 3060 from reaching the hit-line 3020. The human player controls a spaceship 3010 which can be moved to the left or the right using the left and right arrow keys on the keyboard. The player can fire a bullet 3030 upward from the spaceship 3010 by pressing the spacebar on the keyboard. The dashed arrow 3040 indicates the direction the bullet travels.

Next, let's connect the game whose display is shown in FIG. 2 with the schematic of FIG. 1. There will not be one to one correspondence between what we see in FIG. 2 and FIG. 1 because FIG. 2 only shows the display of a game. The other parts of a game are not shown in FIG. 2.

The person who plays the game shown in FIG. 2 corresponds to player1 1010 of FIG. 1. While playing the game in FIG. 2, the player uses the keyboard arrow keys to control the movement of the spaceship 3010. So the keyboard corresponds to the input peripheral 1090 of FIG. 1.

There is software in the game of FIG. 2 which checks if the left and right arrow keys are pressed, and then it moves the spaceship 3010 in response to the key presses. The software also checks if the spacebar has been pressed and fires a bullet. This software to control the spaceship 3010 in response to key presses corresponds to player-action-means 1040 of FIG. 1.

There is software (running on computer hardware) in the game of FIG. 2 which causes the alien spaceship 3060 to move towards the hit-line 3020. The player must shoot bullets 3030 to destroy the alien spaceship 3060 and prevent it from reaching the hit-line 3020. This is the problem that is to be solved by the player and it corresponds to the challenge-means 1030 of FIG. 1.

There is software running on computer hardware in the game of FIG. 2 which animates the movement of the alien spaceship 3060, the player spaceship 3010, and the bullets 3030 on the display 3070. This animated display provides feedback to the player about whether the bullet hit the alien spaceship or if it missed. This animation system corresponds to the feedback-means 1050 of FIG. 1.

The entire game of FIG. 2 including parts which are not shown in FIG. 2 such as the keyboard, computer hardware, and software, together correspond to the game 1020 of FIG. 1.

Instead of a single player game, what if we have a multiplayer game? Consider FIG. 3. This is similar to the game of FIG. 1, but instead of a single player game 1020, we have a two-player game 2020. Many of the components of this two-player game are the same as for a single-player game. But now we have an extra player 1060 who we will refer to as Player2. Player2 uses peripherals 1080 to communicate with another instance of player-action-means 1070.

FIG. 4 illustrates a two-player game similar to the game of tennis. It is played on a level surface called a court 4010. There are markings on the court 4030 which are used to enforce rules about where a ball 4095 may bounce on the ground. There is a net 4040 in the middle of the court. Players are expected to hit the ball 4095 over the net 4040. There are two players. Player1 is 4020. Player1 holds a racquet. A racquet is also called racket. The racket has two parts: A grip (aka handle) 4060 by which the player holds the racket, and a head (aka strings) 4050 by which the player strikes the ball. Similarly, Player2 4070 holds a racket that has a handle 4080 and a head 4090.

Let's map the components of this game to FIG. 3. Player1 4020 corresponds to 1010. The racket handle 4060 corresponds to input peripherals 1090. The racket head 4050 corresponds to player-action-means 1040 by which the player affects action in the game. Player2 4070 corresponds to 1060. The handle of the racket 4080 corresponds to 1080. The head of the racket 4090 corresponds to 1070, a means for the player to affect the game.

Let's suppose Player1 “serves” the ball towards Player2. The ball 4095 traveling towards Player2 and the expectation that Player2 will follow the rules of the game while hitting the ball back corresponds to the challenge 1030 faced by Player2. After Player 2 hits the ball, Player2 is able to see the ball travel across the court. So the material of the ball, the shape of the net 4040, the markings 4030, the physics of the game, the forces of gravity, the hardness of the court, all provide the player with feedback as the ball flies across the court. Together, these correspond to feedback-means 1050.

### Learning-Games in Prior Art for Teaching Coding Skills

Now that we have discussed the components of a game, let's move on to understanding how the prior art has tried to use games to teach students programming and coding skills.

There are two parts to teaching programming and software coding skills. One part is instruction. That is, providing information to students. The second part is exercises and projects. Exercises and projects are where a student learns to use the information that was learned during instruction.

Instruction can be done through written text or through videos. But exercises are a problem. When students are presented with exercises, they often try to skip past the exercises. Students try to obtain answers to exercises by searching the web or by asking a generative AI platform like ChatGPT. Many students need motivation to complete their programming exercises.

One way to provide motivation is through learning-games. The exercises are made as interesting as a game so that students feel motivated to complete their exercises.

Two approaches have been attempted in the prior art to make coding exercises as engrossing as games. Both approaches suffer from unrecognized problems that limit their success.

### Unrecognized Problems in Prior Art Techniques of Gamification

The first approach is called “gamification”. Gamification is about converting boring exercises into engrossing games by adding an entertaining feedback-means 1050 to the exercises.

Books about gamification in the prior art that the reader might wish to study:
1. Actionable Gamification: Beyond Points, Badges, and Leaderboards by Yu-Kai Chou
2. The Gamification of Learning and Instruction: Game-based Methods and Strategies for Training and Education by Karl Kapp

For a concrete example of gamification, consider multiple-choice questions about coding. A question is presented to the student, and then multiple possible answers are shown to the student. The student is asked to select the correct answer from the list of choices. Multiple choice exercises are usually boring.

To “gamify” this boring exercise, the prior art suggests adding flashy graphics and sound effects after the user selects a correct choice to celebrate the students' success in picking the correct answer. On the other hand if the student picks a wrong choice, then the prior art suggests using different graphic-effects and audio-effects to indicate that this is an opportunity for the student to try again and work towards obtaining the correct answer. Optionally, the prior art also suggests adding leaderboards that compare the students' own scores with the high-scores obtained by other students. The leaderboards, flashy-graphics and sound-effects are an implementation of the feedback-means 1050.

Attempts in the prior art to make boring coding exercises interesting for students by “gamifying” coding exercises have largely failed. Gamifying an exercise usually involves presenting the student/player with maximum score leaderboards, flashy graphics, audio-effects, and exciting visuals. These multimedia elements are supposed to provide an engaging feedback when the student provides an answer to the coding exercise. The prior art has failed to recognize that the three components of a game: (1) challenge-means (2) player-action-means and (3) feedback-means, all have to be interesting for a player to remain engrossed in a game.

The prior-art term “Gamifying” means to add exciting feedback-means to boring coding challenges and boring input-forms. The prior art fails to recognize that when the challenge-means is boring or the player-action-means is boring, a gamified exercise is not engrossing for students.

To understand what the prior art has failed to recognize about “gamification”, consider FIG. 5. The prior art has attempted to “gamify” boring coding exercises 5030 and boring multiple-choice questions 5040 by combining them with interesting feedback-means 1050. The prior art (unsuccessfully) attempts to persuade the student that the combination 5020 is an engrossing game.

That is, the prior art has made the mistaken assumption that an exciting feedback-means 1050 alone is enough to make a boring challenge-means 5030 interesting like a game.

The prior art has used score-leaderboards, flashy animations, and multimedia music to implement the feedback-means 1050 and make it interesting. However, the prior art has failed to recognize that the challenge-means should be interesting. So instead of an interesting challenge-means 1030, the prior art presents students/players with boring coding exercises 5030. Instead of an interesting player-action-means 1040, the prior art presents the student/player with a boring multiple-choice answer-input-form 5040.

In other words, a player who uses a “gamified” coding exercise is presented with boring coding tasks 5030 and a boring answer-input-form 5040. The prior art fails to recognize that interesting feedback-means 1050 is by itself not enough to make the combination 5020 an interesting game for the player/student.

Unrecognized Problems in Prior Art Techniques of Replacing Player with Code

Another approach suggested by the prior art is to start with an interesting game and then replace the player action means 1040 with a coding exercise. In other words, we retain the interesting challenge-means 1030 and the exciting feedback-means 1050. We replace the player-action-means 1040 with a coding exercise. The coding exercise that replaces 1040 is supposed to replace the player and automate the actions that the player would normally take.

Let's look at a concrete example. Consider FIG. 6. This is a schematic for a puzzle game. The objective of the game is to place different objects of varying shapes and sizes inside a container. The challenge for the player is to maximize the number of objects that can be packed into the container.

6030 is the container in the schematic of FIG. 6. 6020 is an object that has already been placed within the container 6030. There are other objects already in the container 6030 which are indicated as 6041, 6042, 6043, 6044, 6045, and 6046. The new object 6010 has to be carefully oriented so that it fits into the collection of objects already in the container 6030. The arrow 6015 indicates how the new object 6010 may be placed into the container.

This is a puzzle game. It is not easy to figure out how to orient each object so that the total number of objects that can be packed into the container is maximized. The sequence in which the different objects are to be placed inside the container also has to be figured-out. The challenge-means 1030 corresponds to the player being asked to pack as many objects as possible into the container 6030. The challenge-means 1030 also includes asking the player to figure out how to orient an object 6010 so that the maximum number of objects can be packed into the container. The opening on the top of the container through which the player inserts each object in the appropriate orientation corresponds to the player-action-means 1040. The container 6030 is made of a transparent material like glass. The visual appearance of the different objects that have already been placed visible inside transparent container 6030 serves as the feedback-means 1050.

Next, let's consider how the prior art would modify this game to motivate students to complete their programming exercises. The approach used by prior art is to ask a student to write code that completely automates the actions of a player. That is, in this game, the student is asked to write code to automatically compute the correct orientation of each object as it is added to the container. In other words, the student is asked to write code that automates what a human player of the game would do.

FIG. 7 illustrates the game schematic after the changes suggested by the prior art. The machine 7020 is a changed version of the game 1020. The challenge 1030 has been replaced with a different challenge 7030. The new challenge 7030 is to write a program that automatically places the objects in the container 6030 so that the number of objects that fit is maximized. In other words, the challenge has changed from something for the player to solve, to a challenge that the player should write code to solve.

Instead of the player-action-means 1040, we now have a different player-action-means 7040. 7040 expects the player to enter code. In other words, while 1040 would have allowed the player to manually choose an orientation for each object, 7040 expects the player to enter code and the code will automatically compute the orientation for each object.

Instead of handling objects by hand, the player now uses a keyboard 7090 to enter code.

Observe that the new challenge 7030 is very difficult. Manually figuring out how to orient objects so that they fit within the container is difficult. But figuring out how to write code to automatically compute the best orientation is much more difficult. In other words, we have a challenge 7030 that is much more difficult than the original challenge 1030 of the game we started with.

The player-action-means 7040 is now boring. Manually placing objects in a container is interesting if the objects look and feel good. But doing it automatically involves many hours spent staring at a code editor, and that is usually boring.

The prior art has failed to recognize that replacing 1030 with an automatic coding challenge and replacing 1040 with code editor 7040 results in a machine 7020 which is boring to interact with.

There are other disadvantages in this approach which the prior art has failed to recognize: Students (who are also players) might ask an AI system such as ChatGPT for the answer, or they might look up the answer on the web instead of working on the problem themselves. Coding a program that solves a challenge like 7030 is very difficult and might not be possible for beginners. This can result in students becoming disheartened and giving up.

Next, let's consider a game like golf. The challenge in the game of golf is to analyze wind conditions, the slopes of the land on golf course, the texture of the grass and its resistance to a rolling ball, and then hit the ball with a club so that it travels towards a small hole in the ground a few hundred yards away. This challenge corresponds to 1030.

The player hits the ball and uses the direction of the wind and the properties of the land on the golf course to drive the ball as close as possible to the target hole. This corresponds to the player-action-means 1040.

The physics of the world (gravity and wind) cause the golf ball to fly through the air, bounce on the ground, possibly bounce on some obstacles such as sand or trees, and then come to rest at some location on the golf course. The view of the ball moving towards the target hole corresponds to the feedback-means 1050.

According to the prior art, the game of golf can be altered to become a learning game 8020 as shown in FIG. 8. Instead of figuring out how to manually swing a golf club and hit the ball so that it travels as close as possible to the target hole under the given conditions of wind and land, the player must figure out how to write code that automates a robot. The robot holds a golf club and swings it so that the club hits the ball and the ball travels towards the target hole. This is the challenge 8030 for the player to solve.

Instead of a player gripping the handle of a golf club we have a means 8090 for a player to enter code.

Instead of a player's visual senses and the player's control of muscles in the body, we have a software code 8040 which controls the robot to swing the club and hit the ball.

The student (who is also the player) is supposed to enter code that controls a robot. Golf is not an easy game for a human. Programming a robot to play golf is more difficult. In other words, the prior art has failed to recognize that the challenge 8030 is more difficult than manually playing golf.

Instead of feeling the wind on the body, the warmth of the sun on the player's face, and enjoying beautiful scenery at the golf course, the player has to design code in the challenge 8030. The prior art fails to recognize that the challenge 8030 is boring compared to the original challenge of playing golf.

Instead of feeling a sense of accomplishment at controlling the player's body during the golf swing and enjoying the flight of the ball towards the hole, the player now has to debug robot-control code 8040. The prior art fails to recognize that 8040 is boring compared to player-action-means in the original game of golf.

The prior art technique of replacing a player's manual actions with code that performs those actions automatically has largely failed at designing learning-games.

### SUMMARY OF THE INVENTION

A way to start with a game which is fun to play, and then convert it into a learning-game that continues to be fun to play. This is accomplished by allowing the player to write code that makes constrained changes in the behavior of the challenge 1030, the player actions 1040, and the feedback 1050.

Allowing the player to write code in this manner converts the original game into a learning-game. This is because the player is incentivized to write code that makes it possible for the player to obtain a higher score in the game. The player repeatedly writes and rewrites code while trying to better the score in the game. Repeatedly writing and rewriting code is a good learning experience for the player.

Since the player is making constrained changes in the challenge 1030, player actions 1040, and feedback 1050, the nature of the original game is only changed slightly by the player's code and the learning-game continues to be as much fun to play as the original game.

### BRIEF DESCRIPTION OF DRAWINGS

FIG. 1 is a schematic of a non-learning-game.

FIG. 2 illustrates an example of how a non-learning-game might appear.

FIG. 3 is a schematic of a multiplayer (2-player) non-learning-game.

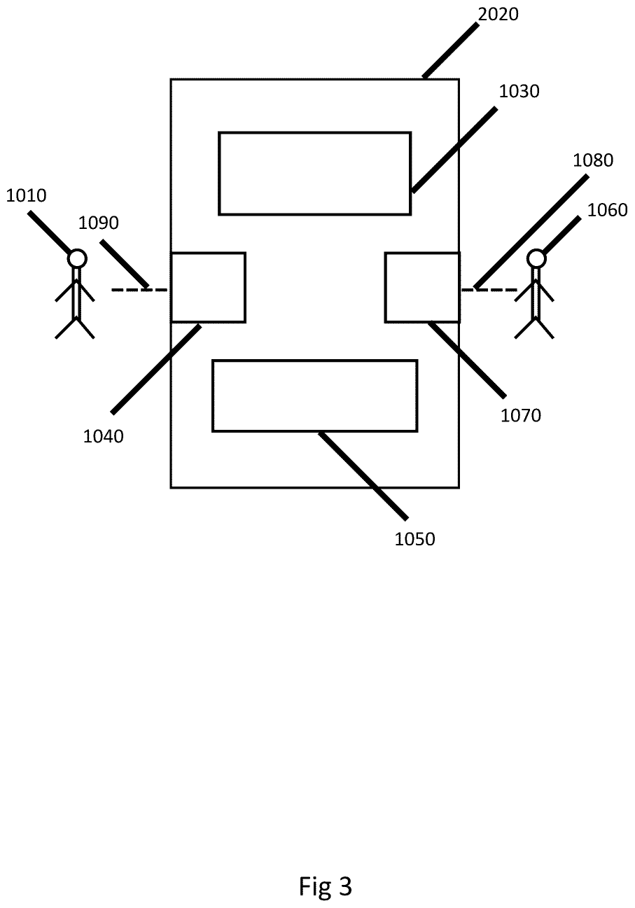

FIG. 4 illustrates an example of a multiplayer non-learning-game similar to Tennis.

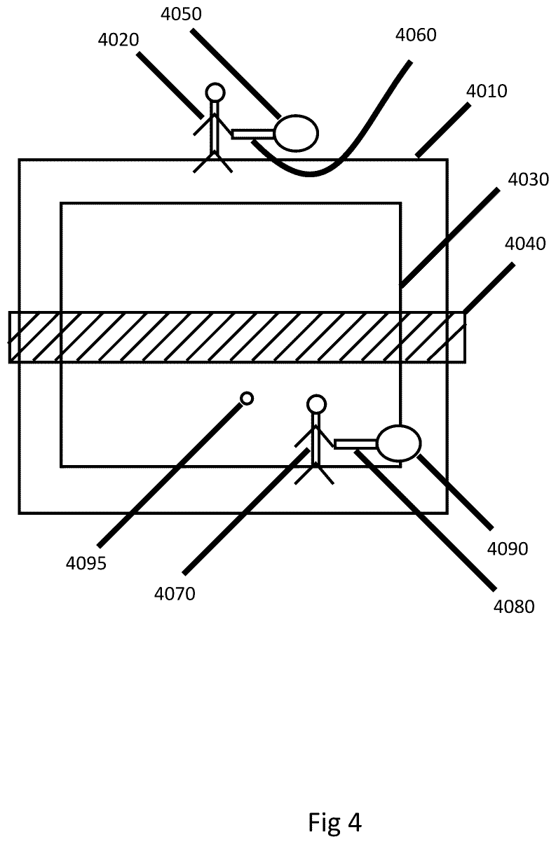

FIG. 5 is a schematic of a “gamified” programming exercise in the prior art.

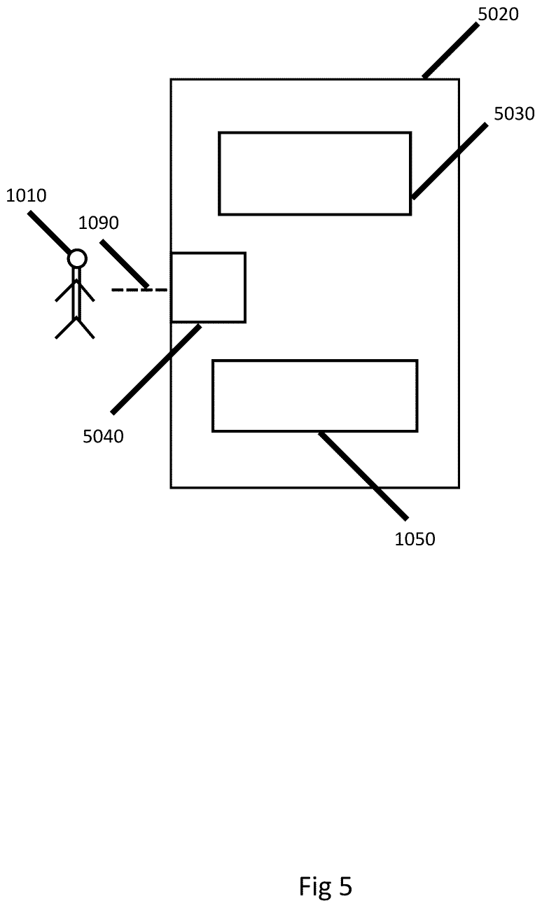

FIG. 6 illustrates an example of a prior art game where the actions of a human player is to be automated/replaced by code entered by the player.

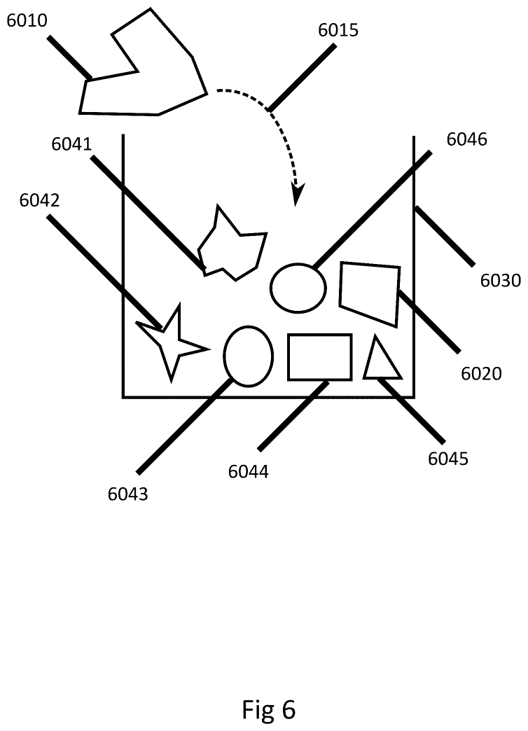

FIG. 7 is a schematic of a prior art game where the actions of a human player have been automated/replaced by code entered by the player.

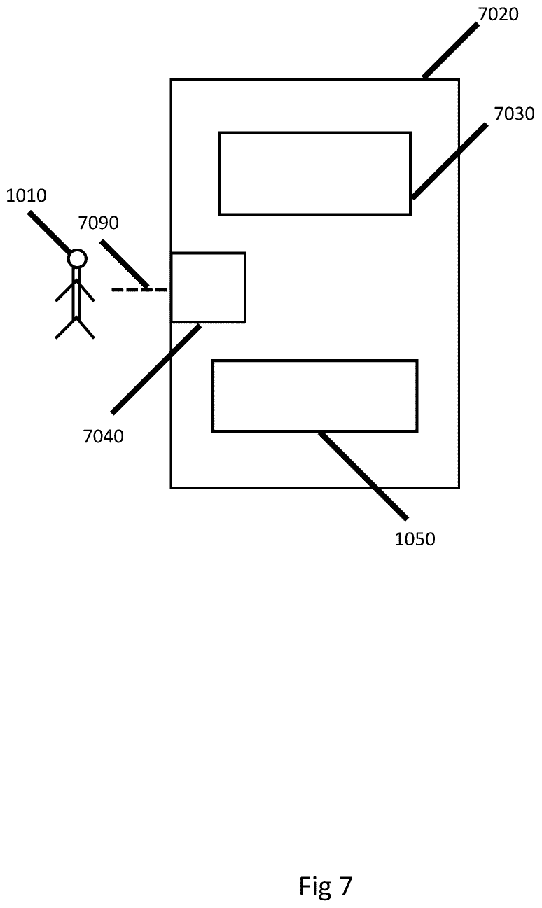

FIG. 8 is a schematic of how in the prior art the actions of a human player of the game of Golf have been automated/replaced by code entered by the player to control a robot that swings a golf club.

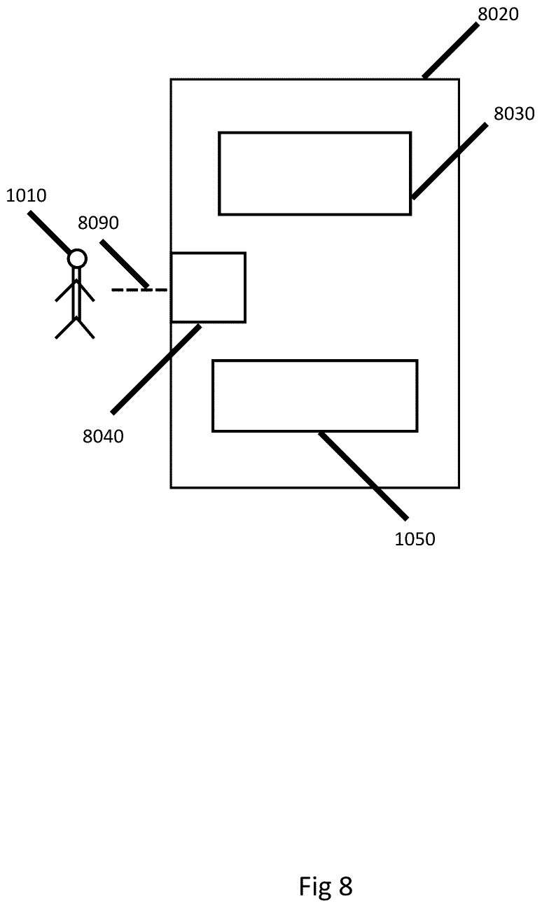

FIG. 9 shows the display of a learning game where players shoot alien spaceships by firing bullets. Players can also enter code to make their bullets home-in on the alien spaceship.

FIG. 10 is a schematic of a learning-game where players shoot alien spaceships by firing bullets. Players can also enter code to make their bullets home in on the alien spaceship.

FIG. 11 illustrates how the sport of car-racing (with real physical cars on real physical tracks) can be made into a learning-game by adding a heads-up display, a computer that is programmable by the player, and sensors.

FIG. 12 illustrates how a game like Tennis becomes a learning-game when the player is given the ability to program their racket to automatically twist on a hinge.

FIG. 13 illustrates a learning-game based on an air-combat simulator.

FIG. 14 illustrates a card game that teaches coding skills.

FIG. 15 illustrates how information in a video can be presented more efficiently as images and text.

### DETAILED DESCRIPTION OF THE INVENTION

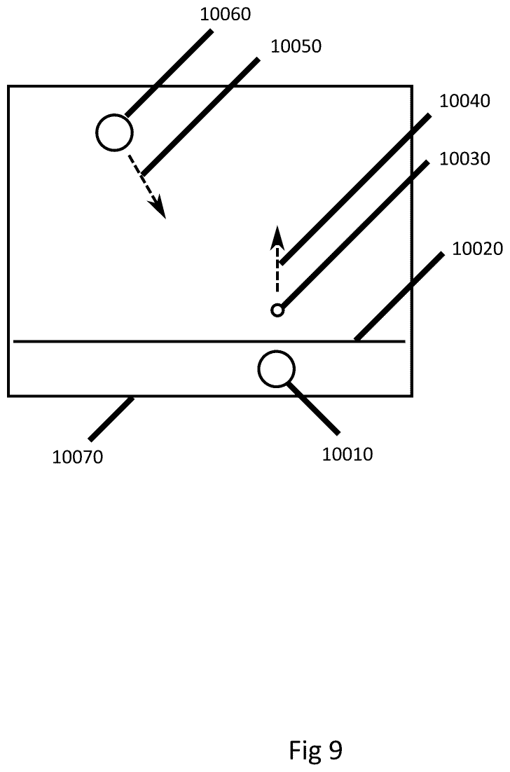

According to one embodiment, we have a game as shown in FIG. 9. 10070 is the display of the game.

10010 is the graphics for a player spaceship. This player spaceship is controlled by the player. The player spaceship 10010 moves to the left or the right when the left or right arrow keys are pressed on the player's keyboard.

10020 is the hit-line which the alien spaceship is to be prevented from reaching. The player is expected to shoot the alien ship before it reaches the hit-line.

When the player presses the spacebar, a bullet 10030 is fired from the player's spaceship. The bullet 10030 moves upward in the direction indicated by the arrow 10040.

10060 is the alien spaceship that is flying towards the hit-line 10020. The direction of the alien spaceship is chosen randomly each time a new alien spaceship appears on the screen. The direction is indicated by the arrow 10050.

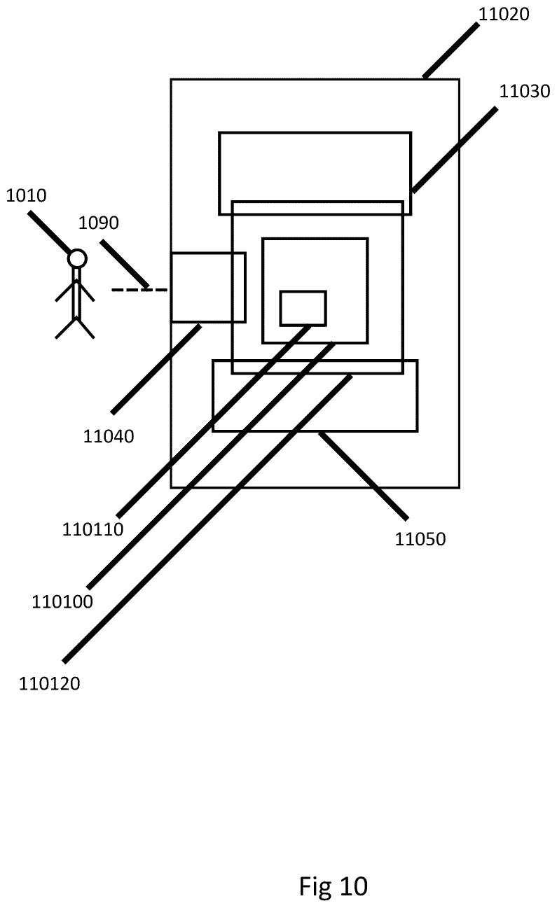

The behavior of the elements of this game can be changed through a constrained coding-means as described in FIG. 10.

1010 is the player “Player1”. 1090 is the input-means by which the player controls actions in the game. In this embodiment, this would be the keyboard.

11040 is the player-action-means. In this embodiment, the behavior of the player-action-means can be changed through code.

11030 is the challenge-means. In this embodiment, the behavior of the challenge-means can be changed through code.

11050 is the feedback-means. In this embodiment, the behavior of the feedback-means can be changed through code.

The code which changes the behavior of 11030, 11040, and 11050 can be entered through the coding-means 110100.

The coding-means 110100 has a band around it labeled 110120. 110120 is the control-means through which the code entered in 110100 can be used to change or control the behavior of at least one of 11030, 11040, or 11050.

Observe that the control-means 110120 is shown on the schematic as overlapping 11040 (player-action-means), 11030 (challenge-means), and 11050 (feedback-means). This is to indicate that the coding-means 110100 can affect many of the mechanics of the game through the control-means 110120, including the player-actions 11040, the game's challenge 11030, and the way the feedback is presented to the player 11050.

Within the coding-means 110100 there is a constraint-means 110110. The purpose of the constraint-means 110110 is to limit the kinds of code that can be entered into the coding means 110100 so that the game 11020 continues to be enjoyable to play.

As a high-level summary, in this embodiment, the player can not only move the defending spaceship and fire bullets using the keyboard (1090), but the player can also add some code using 110100. The purpose of this code is to change some of the game mechanics so that it becomes easier for the player to do well in the game. To prevent the possibility that the code might make it too easy for the player, and thereby destroy the enjoyment of the game, there are constraints 110110 that limit what the code can do.

To be specific, in this embodiment the coding means 110100 allows the player or some other member of the player's team to insert code which can move the bullet 10030 sideways towards the alien spaceship 10050. That is, it is possible to insert code through 110100 which makes the bullet 10030 act like a homing missile which homes in on the target 10050. If this code for the homing bullet were too effective, then the bullet will hit the alien spaceship regardless of how the player controls the defending spaceship. If the homing bullet can never miss, then the game wouldn't be enjoyable to play. So there are constraints 110110 which limit the extent to which the bullet 10030 homes in on its target 10050.

What are the constraints 110110? In this embodiment, when the bullet moves sideways towards its target, the score gets reduced for each sideways movement of the bullet. Therefore, the player is incentivized to minimize the sideways movement of the bullet. Furthermore, the player earns a higher score for each alien spaceship that is shot down if the alien spaceship is further away from the hit line. In other words, even after the coding means 110100 is used to change the game mechanics so that they are favorable for the player, the constraints 110110 ensure that the game remains enjoyable to play.

Let's study the code for this embodiment that is attached to this application.

There are two ways to run the attached source files. Depending on the version of browser and operating system, and depending on security settings, one of the methods may work better than the other. To run the files, ensure the Windows operating system has all security settings turned off. A fresh installation of Windows 11 Home edition single language version 23H2 64-bit on a computer with a x64 processor (such as Intel Core i7-9750H CPU) and 32 GB of RAM is recommended. The default browser should preferably be set to Google Chrome Version 127.0.6533.72 (Official Build) (64-bit). Rename playereditablejs.txt to playereditable.js and rename gamehtml.txt to game.html.

(1) Place the files game.html and playereditable.js in the same folder, and then double-click the file game.html to launch it in the default browser (which should be Google Chrome as specified above).

(2) Alternatively, place the files game.html and playereditable.js in the same folder of a standard webserver (such as Apache) and open the URL of the file game.html from the Google Chrome browser specified above.

The game is implemented in the files game.html and playereditable.js.

The file game.html is not supposed to be edited by the player.

The file playereditable.js corresponds to the coding-means 110100. The player edits this file to insert code into the game.

To implement the constraints 110110, the player is given instructions. We assume that the player follows all instructions and doesn't try to “hack” into the rest of the game:

The player is asked to edit only playereditable.js and not game.html.

The player is also told that the functions getAlienCoordinates, getBulletCoordinates, incrementBulletX, and decrementBulletX can be invoked from the player's code, but no other functions defined within game.html should be invoked.

The player should also not change any of the variables or code definitions that are defined within game.html.

The player is invited to edit the code in playereditable.js in such a manner that when the player plays the game using the keyboard, the player is able to get a higher score.

The default code in playereditable.js (before the player makes any edits) is given in the file playeredit0.txt.

The function customInit( ) gets invoked by the game code during initialization. The function customMechanics( ) gets invoked from the main “game-loop”. Since the “game-loop” is implemented using requestAnimationFrame, the function customMechanics will be invoked approximately 60 times a second. In the initial state of the code, these two functions have empty bodies. The player is expected to insert code into these functions as necessary.

As a first attempt at improving game scores, the player might edit playereditable.js and add code within the function customMechanics. The player might choose to get the current location of the bullet and the current location of the alien ship. If the x-coordinate of the bullet is less than the current x-coordinate of the alien ship, the code increments the x-coordinate of the bullet. If the x-coordinate of the bullet is greater than the current x-coordinate of the alien ship, the code decrements the x-coordinate of the bullet. One possible way the player might choose to implement this idea is given in playeredit1.txt. (Note: The files playeredit1.txt, playeredit2.txt, and playeredit3.txt are not given to the player. These files are included in this application to help us analyze the kinds of code the player might write. The players will write the code on their own as a learning experience.)

After trying out the first attempt of the code and playing the game, the player figures out that calling the function getAlienCoordinates to get the coordinates of the alien spaceship reduces the score each time it is called. To maximize the score, the player wants to minimize the number of times the function getAlienCoordinates is called. The player also realizes that the alien spaceship is moving in a straight line. So after getting the coordinates of the alien spaceship twice, and calculating the speed and direction of the alien spaceship from those two coordinates, the player's code should be able to automatically compute the location of the alien spaceship at any future time. In other words, the player decides that the function getAlienCoordinates should not be called on each iteration of the game-loop. The player's new version of the code might look like the file playeredit2.txt. The player edits the code in playereditable.js to implement code that is similar to playeredit2.txt. The player plays again using the keyboard after making the change in the code of playereditable.js.

The player sees that it is now easier to get a high score. The player also realizes that moving the bullet towards the current location of the alien spaceship is inefficient because sometimes the bullet will move a little to the left and then again a little to the right. Moving left and then reversing direction to move right causes the score to reduce unnecessarily because each sideways movement reduces the score. That is, each sideways movement requires that either incrementBulletX or decrementBulletX be called, and when these functions are called the score gets reduced.

The player is motivated to avoid losing score in this manner. So the player decides to compute the location where the alien ship will be when the bullet reaches it, and then move the bullet's X coordinate to match the X coordinate of the intersection location. The player makes a third change in the code in the file playereditable.js. The code at this point might look like the file playeredit3.txt. The player runs the game again and finds that it is now much easier to get a high score.

In this way, the player makes repeated changes in the code using the coding-means 110100. While changing the code, the player is learning valuable coding skills. The player is motivated to make changes in the code because the game remains enjoyable even after the code changes are inserted. The game of this embodiment 11020 is a learning game which is enjoyable to play.

As a summary of this embodiment: We began with a game that was enjoyable to play. Then we made it possible to change the game mechanics (challenge, player-actions, and feedback) using code. The changes in game mechanics were constrained so that the game remains enjoyable to play. The player is motivated to edit the code to make it easier to get a high score. The player learns coding skills while trying to improve the game-score.

This embodiment can be thought of as follows: We start with a game that is fun to play, and then we add the ability to insert code to make some changes in the game-mechanics. The result is a learning game that can be used to teach coding skills. Observe that the challenge, player-actions, and the feedback of the learning-game are very similar to the challenge, player-actions, and feedback of the original non-learning-game we started with.

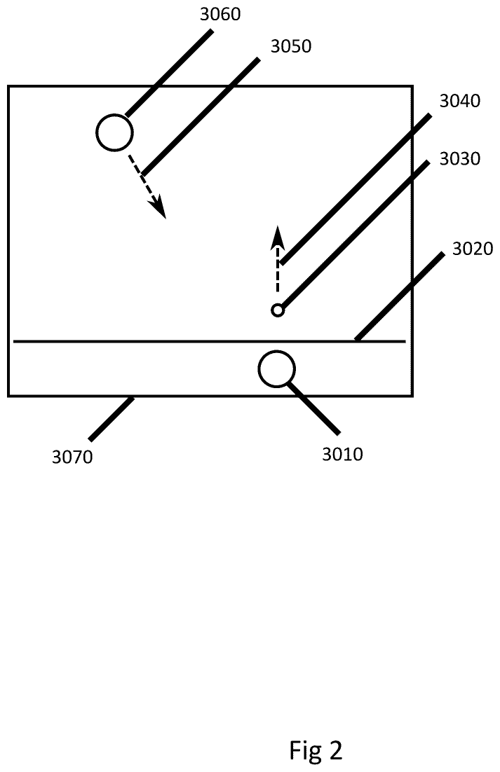

The learning-game described in FIG. 9 is very similar to the non-learning-game on which it is based (described in FIG. 2). In both games, the challenge is to shoot an alien spaceship with a bullet. The player ship in both games is controlled by the keyboard. The graphics (feedback-means) of both games appear almost the same. The difference is that in the learning-game, the player has the option of writing code to have the bullet home in on the alien ship (within some constraints). Both games are fun to play because the game-mechanics of both games are very similar. The learning-game additionally motivates the player to solve coding problems while writing code that helps the player obtain a higher score.

This embodiment represents a way to start with a fun game, and then convert it into a learning-game that is also fun to play.

Let's recap the structure of the learning-game:

The learning-game 11020 has a challenge-means 11030.

The challenge-means 11030 presents a challenge or problem for the player 1010 to solve.

The player 1010 uses input-means 1090 to interact with player-action-means 11040.

The player-action-means 11040 processes the player's choices on how best to address the challenge or solve the problem presented by the challenge-means 11030.

The effects of the player's choices within the game are made apparent through the feedback-means 11050.

The player's choices (aka actions) within the game cause the challenge to be modified, and the modified challenge is presented to the player. The player reacts to this modified challenge, makes new player-action choices, and again obtains feedback on the effect of the player's choices. This is repeated in a loop. Going through this loop is termed “playing the game”.

The player can optionally modify the challenge-means 11030, player-action-means

11040, and the feedback-means 11050 through code to make it easier to play the game. The control-means makes it possible for the code to control the challenge, player-actions, and feedback.

The player enters the modification code using coding-means 110100.

To ensure that the game remains fun to play, there is a constraint-means 110110 which limits the kinds of changes that the modification code can make to 11030, 11040, and 11050.

Let's recap the process by which a player interacts with this game. The process comprises the following steps:

1. The player 1010 perceives a challenge or a problem to solve presented by 11030 a challenge-means. In this embodiment, the player looks at the screen and sees an alien spaceship 10050 moving towards the hit-line 10020. The challenge is to shoot down the alien spaceship before it reaches the hit-line. In other words, the player is perceiving a challenge to solve.

2. The player uses 1090 the player-input-means (in this embodiment, the keyboard) to enter the player's choice (expressed as player-actions 11040) about how to solve the challenge. In this embodiment, the player uses the left and right arrow keys to move the player spaceship 10010 and then fires a bullet 10030 (by pressing spacebar key) towards the alien spaceship. In other words, the player is making an actionable choice towards solving the challenge.

3. The player sees the bullet move upward. The feedback-means 11050 in this embodiment is the computer computing the positions of the bullet and the alien spaceship and displaying them on the screen. The animated display feedback-means shows whether the bullet hits or misses. The changed locations of the bullet and the alien spaceship have changed the challenge. The player will have to figure out how to address the modified challenge. In other words, the player is viewing feedback on how the actionable choice performs in solving the challenge.

4. The player uses 110100 to enter code which obeys the constraints of 110110. Using 110120, this code modifies the behavior of at least one of 11030, 11040, or 11050. That is, the code modifies the behavior of at least one of the challenge-means, the player-action-means, or the feedback-means. The player is motivated to enter code which makes it easier to address the challenges presented by 11030. That is, the player is writing code to make the challenge easier, or the player is writing code that makes the actionable choice easier or more effective for solving the challenge.

Let's recap the process by which we designed this learning game 11020:

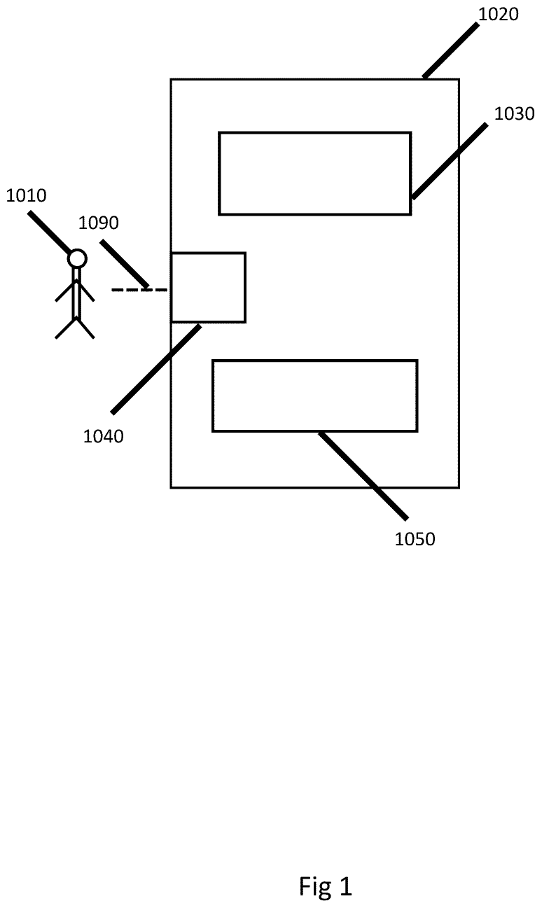

We began with the non-learning-game 1020 described in FIG. 1.

Then we added a coding-means 110100.

We added a control-means 110120 which uses the code entered in 110100 to modify the behavior of at least one of 11030, 11040, or 11050.

We changed 1030 to 11030 so that the challenge-means can connect to the control-means 110120 and be programmed by the code entered in 110100. In other words, the difference between 1030 and 11030 is that the behavior of 11030 can be controlled by 110120 using code entered in 110100.

We changed 1040 to 11040 so that the player-action-means can be programmed by 110120 using the code entered in 110100.

We changed 1050 to 11050 so that the feedback-means can be programmed by 110120 using the code entered in 110100.

We added a constraint-means 110110 to ensure that the code entered in 110100 doesn't alter the fundamental nature of 11030, 11040, and 11050. The constraint-means ensures that even after code is entered to modify 11030, 11040, or 11050, the game remains fun to play.

After these changes, the non-learning-game 1020 of FIG. 1 becomes the learning-game 11020 of FIG. 10.

Note: The control-means 110120 connects to and controls at least one of 11030, 11040, or 11050. 110120 doesn't need to connect with all of 11030, 11040, and 11050.

### Another Embodiment: Learning-Game Based on a Car-Racing Video Game

According to another embodiment, we begin with a car racing video game. The original car racing video game has a steering wheel which is controlled by the left and right arrow keys of the player's keyboard. The accelerator and brake are controlled by the up and down arrow keys on the keyboard. The gears shift automatically according to a standardized mechanism implemented in the original video game. This original game that we start with is fun to play.

The behavior of this original video game is not personalized for the driving style of each player. Some players will drift (let the car slide sideways) through curves on the road, while others will slow down before the curve and accelerate after the curve. Some players will take risky overtaking opportunities, while other players will be more cautious. Some players will focus on reducing damage to their car, while others will focus on winning no matter the damage to their own car or to the racetrack.

Next, we modify the original non-learning-game and convert it to a learning-game. We add coding-means and constraint-means to help the player add code that changes the game mechanics. To be specific, the player can insert code to change the way the automatic gear shift operates. The automatic gear shift mechanism is governed by an algorithm that determines when the gear shifts up, and when it shifts down. A player with an aggressive style of driving might get the highest score with an algorithm that is optimized for better acceleration. A player with a cautious style of driving might get the highest score with an algorithm that is optimized for endurance.

We add constraint-means to ensure that at most one gear shift can happen every second. That is, gears cannot shift too fast.

The coding-means and constraint-means will help the player optimize the automatic gear shift mechanism to suit the player's own style of driving.

While optimizing the gear-shift algorithm to suit their own style of driving, the player learns valuable coding-skills. The player is motivated to continue playing the game and making multiple optimizations of the gear-shift-algorithm because the learning-game is as much fun to play as the original non-learning-game.

We began with a non-learning car racing video game. Then we added coding-means and constraint-means to help the player customize the automatic-gear-shift. With this addition, the racing game becomes a learning-game. The player is motivated to adjust the automatic-gear-shift algorithm so that the player can get higher scores.

Observe that the optimal gear algorithm for one player will be different from the algorithm that suits a different player. Each player will require a different algorithm. So players cannot copy the code from the web or from ChatGPT. Players need to develop the algorithm themselves. This prevents cheating and ensures that players learn coding skills.

The learning game based on car racing described here has the following machine structure comprising:
a. A coding-means for enabling a user to enter code.
b. A constraint-means for limiting the effects of the code entered by the user. The code should be limited to shifting gears, at a maximum rate of one gearshift per second.
c. A challenge-means for posing a challenge to be solved to the user. In car-racing, the challenge is to drive the car and win the race.
d. A player-action-means for processing a choice entered by the user for addressing the challenge. In car-racing, the player operates the steering wheel, the accelerator, and the brake (using the keyboard as input-means) to address the challenge of winning the race.
e. A feedback-means for communicating effects of the choice to the user. In car-racing, when the player turns the steering wheel, the car moves on the road, and a visual representation of how the car moves is shown on the screen. This visual of what is visible out of the front windshield of the car provides feedback to the player on their performance in the race.
f. A control-means connecting the coding-means with at least one of the challenge-means, the player-action-means, or the feedback-means. In this embodiment, the code controls the automatic gearshift. A good algorithm for shifting gears makes the challenge easier, and helps the player take more aggressive actions on the road. So the entered code has to interact with the challenge-means and the player-action-means in the racing game.

The player who uses this embodiment performs the following steps comprising:
a. Perceiving a challenge to solve. The player looks at the visual representation of the race track shown on the screen and tries to figure out how to win the race.
b. Making an actionable choice towards solving the challenge. The player chooses to turn the steering wheel, accelerate or brake. The choice of which action to take and when to take it will determine how well the player performs in the game.
c. Viewing a feedback on how the actionable choice performs in solving the challenge. As the player turns the steering or presses the accelerator, the car will be shown to move on the track and among other cars. This display on the screen provides a visual feedback for the player.
d. Writing code to make the challenge easier, or writing code that makes the actionable choice easier or more effective for solving the challenge, or writing code that makes the feedback more effective for solving the challenge. The player uses the coding-means to enter a new algorithm for automatic gear-shift. The purpose of this code is to make it easier for the player to win the race. The code is supposed to make the challenge (of winning the race) easier and make it easier to control the car (player-actions become easier).

Making a car-racing learning-game based on a car-racing non-learning-game involves performing the following steps comprising:
a. Selecting a game that is fun to play, such that the game has a challenge-means, a player-action-means, and a feedback-means. The racing-car game chosen in this embodiment has a challenge-means which is the race that the player is supposed to win, it has player-action-means which are the car controls (steering wheel, accelerator, and brake), and feedback-means which is the visual animation of the race displayed on the screen. This is the non-learning-game we start with.
b. Adding a coding-means to the game. We add a way for the player to enter code to control the automatic gear-shift.
c. Adding a control-means to the game. We add a way for the code entered by the player to change the way the car's gears shift.
d. Adding a constraint-means to the game such that the constraint-means ensures that the game remains fun to play after code is entered into the coding-means. We limit the rate at which the player's code can change gears. The player's code can shift only one gear per second. This limit is meant to prevent the game from becoming too easy to play. With this limit, the game remains fun to play. We also ensure that the entered code cannot interfere with other parts of the racing game.
e. Changing the challenge-means so that said challenge-means can be controlled by said control-means, or changing the player-action-means so that the player-action-means can be controlled by the control-means, or changing the feedback-means so that the feedback-means can be controlled by the control-means. The code entered by the player has to be able to control the automatic gear-shifts. We need to change the existing gear-shift code to use the player's code instead.

### Another Embodiment: Learning-Game Based on Racing Real Cars on Real Tracks

Consider the sport of racing real (physical) cars on real (physical) tracks. Suppose that all the cars that are being raced on the track are of the same model and year of manufacture. In a race like this the main determinant of who wins is the skill of the driver.

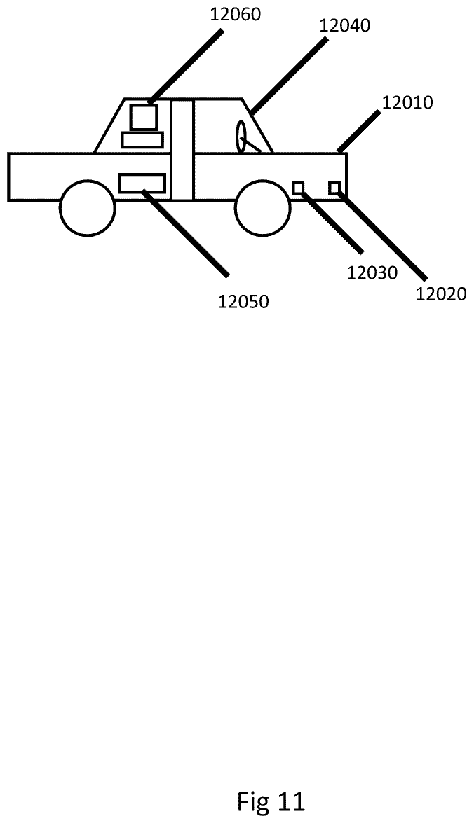

According to another embodiment, we can convert this car racing sport into a learning game. Consider FIG. 11.

We add sensors to each car body 12010. We add a range sensor 12020 that gets data about how far away obstacles and other cars are. We add a traction sensor 12030 that gets data about how well the tires are gripping the road. We can add other sensors as well. An on-board computer 12050 gathers data from all the sensors and displays information on an HUD 12040. A HUD is a “Heads-Up-Display”. Information is projected onto the front windshield “heads-up” so that the driver can read the data easily. We add a coding-means 12060 to allow the driver to change the code in the on-board computer. The changed code can display data from the sensors processed with different algorithms on the HUD. In this embodiment, the coding-means 12060 is a laptop which can be connected to the on-board computer 12050. Note: The driver doesn't change the code while driving. The driver changes the code while preparing for a race. The constraint-means is the physical limitations of the sensor hardware and the HUD hardware. All cars in a race have the same hardware. The driver cannot rewire the on-board computer to give it more sensors or to give it more hardware capabilities.

Each driver is invited to reprogram their own on-board computer so that it processes their car's sensors in a way that is optimal for their own style of driving. For example one driver might want to use colors to indicate when other cars are getting too close. So red color on the HUD might indicate that there are cars nearby, while green might indicate that the area is clear. Another driver might be color-blind and opt to use shapes on the HUD to warn of nearby obstacles. A driver who likes to overtake might customize their HUD to provide more information about nearby cars. A driver who likes to drift/slide during turns might customize their HUD to provide more information about tire traction and brake-locking.

Drivers are motivated to optimize the code in their onboard computer because they wish to win the car race. Drivers will repeatedly edit and test different algorithms to find one that suits their own driving style. Drivers will also change their algorithms depending on who they are competing with. That is, the optimal algorithm depends not only on the driver's own style of driving, but it also depends on the driving styles of the other competing drivers on the racetrack. This means that drivers cannot copy standard algorithms from the web. They need to develop their own algorithms and they will need to tweak these algorithms for each race.

Since drivers repeatedly solve coding problems, this embodiment is an effective learning game for teaching programming skills.

The learning game based on car racing described here has the following machine structure comprising:
a. A coding-means for enabling a user to enter a code. The user/player enters code between races to analyze the data from sensors and display information in the heads-up-display.
b. A constraint-means for limiting the effects of the code entered by the user. The user's code should not affect engine operation or other features of the car. It is constrained to getting data from sensors and displaying information on the HUD.
c. A challenge-means for posing a challenge to be solved to the user. The car, other participants in the race, and the track are the challenge. The player's challenge is to win the race.
d. A player-action-means for processing a choice entered by the user for addressing the challenge. This is the steering mechanism of the car, accelerator pedal, and the brakes. The engine responds to the accelerator pedal, so that is also involved in processing the player's choices.
e. A feedback-means for communicating effects of the choice to the user. This is the windshield through which the player can look out of the car and see what is happening outside. It includes engine noise which tells the player how the engine is running. The speedometer and other dials on the car's instrument panel are also part of the feedback-means.
f. A control-means connecting the coding-means with at least one of the challenge-means, the player-action-means, or the feedback-means. In the car, the on-board computer connects to a HUD which displays information on the windshield. The HUD is the control-means which allows the code written by the player to control the feedback-means (view of road through windshield).

The player who uses this embodiment performs the following steps comprising:
a. Perceiving a challenge to solve. The driver of the racing car is challenged to win the race. The driver should also avoid crashing the car.
b. Making an actionable choice towards solving said challenge. The driver chooses how to turn, when to accelerate, and when to brake. These actions, if performed well, can result in the driver winning the race.
c. Viewing a feedback on how the actionable choice performs in solving the challenge. The driver looks out of the windshield and the side-windows of the car to see how the race is progressing.
d. Writing code to make said challenge easier, or writing code that makes said actionable choice easier or more effective for solving said challenge, or writing code that makes said feedback more effective for solving said challenge. Between races, the driver (or the driver's team) edits the HUD code to provide better data during the race. That is, the code is making the challenge easier, and the code also improves the feedback through the HUD about how the race is progressing.

Making a car-racing learning-game based on a car-racing non-learning-game involves performing the following steps comprising:
a. Selecting a game that is fun to play, such that the game has a challenge-means, a player-action-means, and a feedback-means. In this embodiment, we choose the sport of car-racing. It has challenge-means, player-action-means, and feedback-means.
b. Adding a coding-means to the game. That is, we add a way to program an on-board computer in the car.
c. Adding a control-means to the game. We implement a way for the on-board computer to display something on the windshield. This would be controlling the feedback-means.
d. Adding a constraint-means to the game such that the constraint-means ensures that the game remains fun to play after code is entered into the coding-means. We limit the capability of the on-board computer to work within the hardware of the sensors and the HUD. The code is constrained to not affect any other operations of the car.
e. Changing the challenge-means so that the challenge-means can be controlled by the control-means, or changing the player-action-means so that the player-action-means can be controlled by the control-means, or changing the feedback-means so that the feedback-means can be controlled by said control-means. In this embodiment, we change the challenge to make it easier to win the race. We change the feedback by adding a heads-up-display (HUD) to what the driver sees when looking ahead through the windshield.

### Another Embodiment: A Learning-Game Based on a Ball Game Like Tennis

According to another embodiment we begin with the game of tennis. We change the rules to allow players to wear electronic goggles over their eyes. The goggles are transparent like glasses, but in addition they have a heads-up-display which can be seen by the wearer. There is a small lightweight computer which is worn by the player. The lightweight computer controls what is shown on the heads-up-display of the goggles. The goggles also have a camera and sensors which can track the movement of the tennis ball. The player is invited to insert code into the lightweight computer so that the heads-up-display provides information that the player can use to win more games.

For instance, the sensors and camera can track the ball and provide an indication to the player about whether the player should run faster towards the ball. The display might also provide an indication to the player about where the ball is likely to be when the player reaches the ball. Each player will insert code specific to that player's style of playing. Since code in the lightweight computer can help the player win, the player is motivated to learn coding skills. In other words, the modified version of tennis described here is a learning-game. This learning game is fun to play because it preserves most of the game mechanics of the original game that we started with (tennis).

Players implement original algorithms that support their own style of play. So they do not benefit if they copy standard code from the web. Players not only have to customize the code for their own style of play, but they also need to customize the code for the style of each opponent. So they will be editing the code often and trying out different algorithms. Repeatedly changing the algorithms improves the players' coding skills.

The learning game based on tennis described here has the following machine structure comprising:
a. A coding-means enabling a user to enter a code. This is the way the player (or someone on the player's team) will program the lightweight computer.
b. A constraint-means for limiting the effects of the code entered by the user. The lightweight computer is limited by its hardware to using data from the camera and sensors. The computer is constrained to not communicate with other computers nearby to collect more data. These are the constraints on the capabilities of the software code which runs on the lightweight computer.
c. A challenge-means for posing a challenge to be solved to the user. The other game elements including the ball and the tennis-court present a challenge to be solved by the player to win the game.
d. A player-action-means for processing a choice entered by the user for addressing the challenge. The player addresses the challenge by using the racket to hit the ball. The player actions include running and hitting the ball. The player chooses how hard to hit the ball and in which direction.
e. A feedback-means for communicating effects of the choice to the user. The player can look through the goggles and see the ball travel over the court. There are lines on the court to provide feedback on whether the ball bounces where it should or if it overshot.
f. A control-means connecting the coding-means with at least one of the challenge-means, the player-action-means, or the feedback-means. In this embodiment, the computer worn by the player is connected to the goggles where it controls a HUD (heads-up-display). That is, the control-means connects the coding-means with the feedback-means. The feedback means is the HUD in the goggles.

The player who uses this embodiment performs the following steps comprising:
a. Perceiving a challenge to solve. Player can see the ball coming towards them. They need to hit the ball back to the other side of the court. The challenge is to hit the ball effectively and win the game.
b. Making an actionable choice towards solving the challenge. Players choose how to hit the ball—how hard and in which direction?
c. Viewing a feedback on how the actionable choice performs in solving the challenge. Players look through the goggles and see the ball travel across the court after they hit it. Lines on the court indicate if the ball bounced within the boundaries.
d. Writing code to make the challenge easier, or writing code that makes the actionable choice easier or more effective for solving the challenge, or writing code that makes the feedback more effective for solving the challenge. In this embodiment, the code provides more effective feedback through the data display in the goggles worn by the player.

Making a learning-game based on tennis involves performing the following steps comprising:
a. Selecting a game that is fun to play, such that the game has a challenge-means, a player-action-means, and a feedback-means. We choose to base the learning-game on Tennis. Tennis is fun to play, it offers an interesting challenge for players, there is a racket to hit the ball across the court (player-action), and markings on the court provide feedback on whether the ball bounces correctly.
b. Adding a coding-means to the game. We add a way for the player to program the display in the goggles.
c. Adding a control-means to the game. The computer worn by the player has a way to control the display in the goggles.
d. Adding a constraint-means to the game such that the constraint-means ensures that the game remains fun to play after code is entered into the coding-means. The constraint here is that the goggles don't give such an unreasonable advantage to the player that the game becomes boring. The computer is limited in what it can do. It can process information from the camera and sensors, but it cannot network with other computers. It can only show data in the goggles, it cannot move a robot or some other such means to hit the ball automatically.
e. Changing the challenge-means so that the challenge-means can be controlled by the control-means, or changing the player-action-means so that the player-action-means can be controlled by the control-means, or changing the feedback-means so that the feedback-means can be controlled by the control-means. In this embodiment, the feedback-means has been changed by the addition of goggles so that the player can be shown additional information. The control-means can cause information to be displayed within the goggles.

### Another Embodiment—an Alternative Learning-Game Based on Tennis

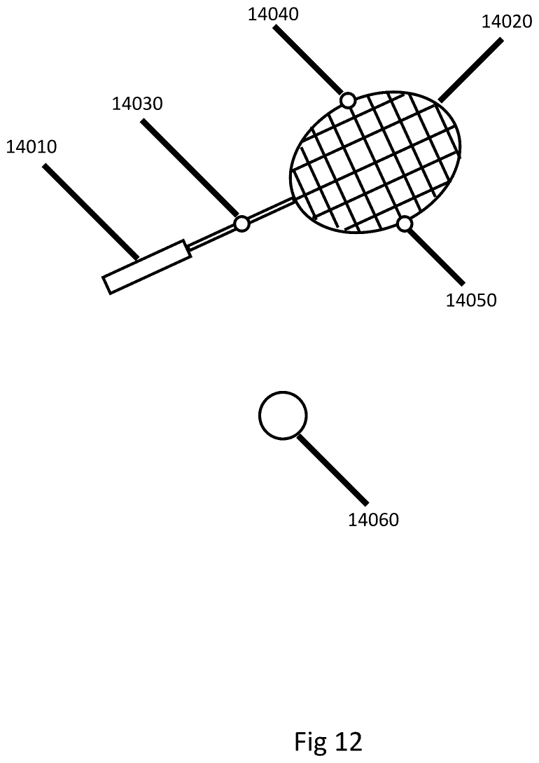

According to another embodiment we start with a game similar to tennis. Consider FIG. 12.

The racket (aka racquet) for this game is similar to a tennis racket. It has a grip 14010 like a tennis racket, and a head 14020 with strings. In addition, it has a hinge-means 14030 which allows the head to twist under the control of software code. It also has sensor means 14040 and 14050 which can track a ball 14060 as it moves towards the player.

The player can insert code to control the hinge-means 14030. By controlling the hinge-means 14030, the code can twist the head 14020 and control the angle at which the heads 14020 strikes the ball 14060. The player is motivated to design the code so that when the racket strikes the ball, it does so at an optimal angle. That is, the player writes code which controls the hinge 14030 so that when striking the ball, the head 14020 automatically twists/rotates to the optimal angle to help the player get a better score in the game.

The optimal angle of rotation depends on the player's style of play. If the player likes to use top-spin, the angle at which the head should twist will be different than if the player likes to use back-spin. In addition, the player will want to change the algorithm depending on the playing style of the opponent. So the player will have to develop the code on their own without copying from the web. Modifying the tennis racket as described here results in a learning-game that is fun to play and also produces an effective learning (of coding skills) for the player.

Furthermore, the ideal algorithm for twisting the racket-head also depends on the code entered by the opponent into their racket. To be most effective, each time the opponent reprograms their racket, the player ought to reprogram their own racket as well. This means that the code is continuously being edited and optimized, thereby giving the player more coding-experience.

The learning game based on Tennis described here has the following machine structure comprising:
a. A coding-means for enabling a user to enter a code. We provide a way for the player to enter code to control the hinge-means.
b. A constraint-means for limiting the effects of the code entered by the user. The code can only move the hinge. Other aspects of the game are not affected by the code.
c. A challenge-means for posing a challenge to be solved to the user. The player is challenged to win the game by hitting the ball across the court skillfully.
d. A player-action-means for processing a choice entered by the user for addressing the challenge. The player uses the racket to hit the ball. The player chooses how to hit the ball.
e. A feedback-means for communicating effects of the choice to the user. The user/player can see if the ball bounces within the markings on the court.
f. A control-means connecting the coding-means with at least one of the challenge-means, the player-action-means, or the feedback-means. In this embodiment, the control-means connects the coding-means with the player-action-means. That is, the coding-means can control the angle of the hinge. This is accomplished by a stepper motor in the hinge.

The player who uses this embodiment performs the following steps comprising:
a. Perceiving a challenge to solve. The challenge is to win the game by hitting the ball across the court.
b. Making an actionable choice towards solving the challenge. The player decides how to hit the ball.
c. Viewing a feedback on how the actionable choice performs in solving the challenge. The player can see the ball fly across the court and bounce. The ball is supposed to bounce within the line markings on the court.
d. Writing code to make the challenge easier, or writing code that makes the actionable choice easier or more effective for solving the challenge, or writing code that makes the feedback more effective for solving the challenge. By programming the operation of the hinge, the player is making the actionable choice more effective.

Making a learning-game based on Tennis involves performing the following steps comprising:
a. Selecting a game that is fun to play, such that the game has a challenge-means, a player-action-means, and a feedback-means. We select Tennis which is fun to play and has a challenge-means, a player-action-means, and a feedback-means.
b. Adding a coding-means to the game. We allow the player to insert code to program the operation of the hinge.
c. Adding a control-means to the game. We add a way for the player's code to control the hinge.
d. Adding a constraint-means to the game such that the constraint-means ensures that the game remains fun to play after code is entered into the coding-means. The code is allowed to control the hinge using data from sensor-means on the racket. The code cannot communicate with other sensors or other computers. Since the code is constrained/limited in capability, the game is still a challenge for the player and it remains fun to play.
e. Changing the challenge-means so that the challenge-means can be controlled by the control-means, or changing the player-action-means so that the player-action-means can be controlled by the control-means, or changing the feedback-means so that the feedback-means can be controlled by the control-means. The hinge has a stepper motor so that the code entered by the player can adjust the angle of the hinge. That is, the control-means is a stepper motor which helps the code control the angle of the hinge.

### Another Embodiment: A Learning-Game Based on Golf

According to another embodiment, we start with the game of golf. We change the rules of the game so that the player is allowed to wear goggles during the game. The goggles have a display on which information can be displayed to the player. The player is provided a coding means by which the player can write software that controls the display in the goggles. The player can place sensors at different locations on the golf course. These sensors can measure useful information such as the speed of the wind, the direction of the wind, the distance between the players current location and the hole, and so on. These sensors communicate wirelessly with the computer that is embedded within the goggles and controls the display of the goggles. The player's code can use the information sent by these sensors to display useful and actionable information in the display of the goggles.

The player is incentivized to develop code which helps the player get a better score in the game. The player is incentivized to write and edit the code multiple times as different heuristics are explored. Since the player writes code multiple times in an attempt to develop a good heuristic algorithm, this is a good learning experience for the player. In other words, this is an effective learning game.

This game remains fun to play. Other than the addition of the programmable goggles the game is identical to golf. While playing this game the player will feel the sun on their face, feel the wind around them, enjoy the beautiful scenery, and feel a sense of accomplishment as the ball they strike arcs through the air and moves towards the hole. In other words, this is a learning game which is as enjoyable to play as golf.

Summary: The grip by which the player holds the golf club corresponds to 1090. The shaft and head of the golf clubs correspond to 11040, the player-action-means. The target hole, the wind conditions, the trees and other obstacles, together correspond to 11030, the challenge-means. The view of the golf-course and the ball flying through the air while avoiding trees, correspond to 11050, the feedback-means. The code editor hardware and software through which the player programs the sensors and the goggles corresponds to 110100, the coding-means. The code is constrained from doing anything to affect the flight of the ball or disturb other players using the constraint-means (corresponds to 110110). The code entered by the player displays information on the goggles which the player can use to improve performance in the game (corresponds to the control-means 110120).

### Another Embodiment: A Learning-Game Based on Air Combat Simulator

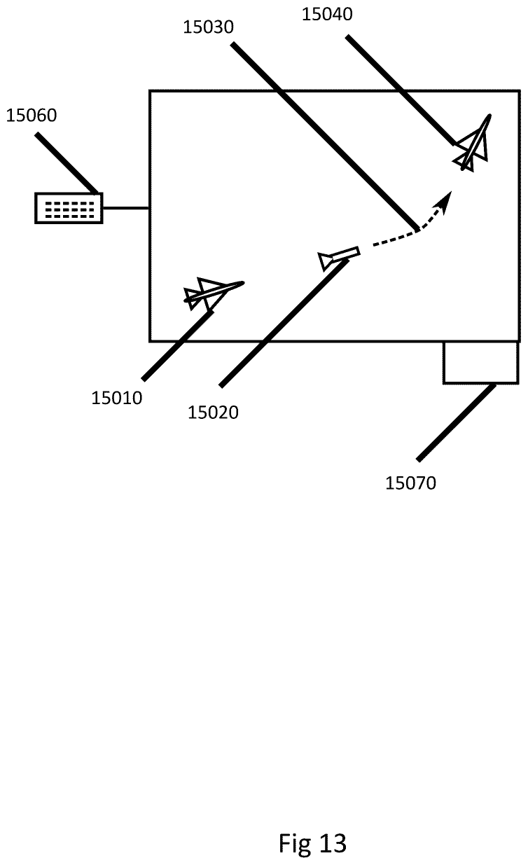

According to another embodiment, consider an air-combat simulator as shown in FIG. 13.

The player controls a simulated fighter-jet 15010. The player's fighter jet fires a missile 15020 which travels along a path shown by the arrow 15030 towards an enemy fighter-jet 15040. The default algorithm used by the missile 15020 to home in on the enemy 15040 is not very effective. The player is provided a coding-means 15060 to edit the code used by missiles for homing in on enemy aircraft.

The simulator ensures that the laws of physics are followed by missiles and aircraft. The physics-simulation-algorithm of the simulator serves as constraint-means 15070 for the code that controls the missile. A homing missile that has been programmed by the player still has to follow the laws of physics.

The player is motivated to implement algorithms for the missile that suit the player's style of flying. This learning-game is fun to play. The player can control an aircraft and fight against simulated enemy aircraft. Each time the player engages an enemy aircraft, the player can test out the efficacy of their own homing algorithm.

Each player will have their own unique style of flying in combat. The enemy aircraft 15040 is controlled by the simulator software. The simulator software is designed to customize the style of play of the enemy aircraft for each player so that each player is faced with a simulated opponent that has a unique style of flying. In other words, the simulator software ensures that the simulated opponent of a player will have a different flying style than the simulated opponent of any other player. This means that the flying style of player aircraft and the flying style of the opponent aircraft are both unique. So the player cannot get the best algorithm for the missile from the web. The player has to develop the code on their own. It will require multiple iterations before the player is able to develop a good homing algorithm. So this learning-game is effective at teaching the player coding skills.

The learning game based on an air combat simulator described here has the following machine structure comprising:
a. A coding-means for enabling a user to enter a code,
b. A constraint-means for limiting the effects of the code entered by the user. The code should not be able to make the missile defy the laws of physics. In addition, the code is limited to changing the homing algorithm of the missile. The code doesn't have access to any other functionality of the simulator such as how the simulated aircraft behaves.
c. A challenge-means for posing a challenge to be solved to the user. The user/player has to shoot down enemy aircraft and win the game.
d. A player-action-means for processing a choice entered by the user for addressing the challenge. The player chooses how to fly the simulated aircraft. The player chooses when to fire a missile and then fires it according to that choice.
e. A feedback-means for communicating effects of the choice to the user. The air combat simulator displays a view of the world seen from the player's cockpit. It also has simulated instruments that display how the aircraft is flying. A successful hit with a missile is displayed as a simulated explosion.
f. A control-means connecting the coding-means with at least one of the challenge-means, the player-action-means, or the feedback-means. In this embodiment, the code entered by the player/user is used to control the homing algorithm of the missile. That is, the code is used to control the challenge-means and make the challenge easier for the player. The control-means connects the coding-means to the challenge-means.

The player who uses this embodiment performs the following steps comprising:
a. Perceiving a challenge to solve. The player sees the enemy aircraft looking out of the simulated cockpit. The player's simulated control panel also indicates incoming enemy aircraft.
b. Making an actionable choice towards solving the challenge. The player chooses how to fly the simulated aircraft and controls the aircraft according to that choice. The player chooses when to fire the missile and fires it according to that choice.
c. Viewing a feedback on how the actionable choice performs in solving the challenge. The player can see how the player's choices in flying the aircraft and firing missiles affects combat with the simulated enemy aircraft.
d. Writing code to make the challenge easier, or writing code that makes the actionable choice easier or more effective for solving the challenge, or writing code that makes the feedback more effective for solving the challenge. In this embodiment, the code makes the challenge easier. If the homing algorithm works well, it makes it easier to shoot down enemy aircraft.

Making a air combat learning-game based on an air combat non-learning-game involves performing the following steps comprising:
a. selecting a game that is fun to play, such that the game has a challenge-means, a player-action-means, and a feedback-means. We choose a suitable air combat simulator that is fun to play.
b. Adding a coding-means to the game. We add a code editor that the player can use to enter code.
c. Adding a control-means to the game. We change the air combat simulator so that the code entered by the player is used to control the flight of the missile.
d. Adding a constraint-means to the game such that the constraint-means ensures that the game remains fun to play after code is entered into the coding-means. For the game to remain fun to play, we limit the capability of the entered code. The code can only control the missile's homing behavior. The missile has to continue to obey the laws of physics. The code cannot affect other aspects of the flight simulation.
e. Changing the challenge-means so that the challenge-means can be controlled by the control-means, or changing the player-action-means so that the player-action-means can be controlled by the control-means, or changing the feedback-means so that the feedback-means can be controlled by the control-means. We change the challenge-means (the homing system of the simulated missile) so that it uses the code entered by the user.

### Another Embodiment: Learning-Game Based on a Strategy Computer Game

According to another embodiment, we start with a strategy computer game. The strategy game is about building cities, managing resources, and helping the cities grow. The player inputs the next “move” in the game using the mouse and keyboard. Each turn of the game is played against the clock. That is the player has limited time in which to choose the next move. In addition to inputting the choice of the next move, the player has access to a coding-means by which some code that the player has input is executed before each turn of the game. The purpose of the code input by the player is to execute heuristic algorithms that analyze the current state of the game, and then advise the player on possible next moves. That is, the player can input code which acts like an AI advisor that suggests next moves.

Since the player has to choose the next move in a limited period time, having an AI advisor that suggests good moves can help the player win. In other words, the player is motivated to develop a good heuristic AI assistant that can help win the game. The player will implement different heuristics in an iterative manner to improve the accuracy of the AI advisor. So this is an effective learning-game for teaching software coding skills.

The strategy game based on city building described here has the following machine structure comprising:
a. A coding-means for enabling a user to enter a code. The game has a code editor that the user/player can use to enter code.
b. A constraint-means for limiting the effects of the code entered by the user. The code can read and analyze the game state. It cannot change the game state. That is, the code cannot cheat the game and give the player's cities super-growth.
c. A challenge-means for posing a challenge to be solved to the user. The display of the strategy game shows the city-building challenge that the player/user is supposed to solve.
d. A player-action-means for processing a choice entered by the user for addressing the challenge. The game has the ability to get input from the user/player on how the cities are to be built and change the game state according to the user's choices.
e. A feedback-means for communicating effects of the choice to the user. The game computes the effects of the player's choices, updates the state of the cities in the game, and displays the updated cities' state to the user/player.
f. A control-means connecting the coding-means with at least one of the challenge-means, the player-action-means, or the feedback-means. In this embodiment, the control-means connects the coding-means with the feedback-means. The code entered by the player analyzes the state of the cities in the game, uses heuristic algorithms to compute good next moves for the player, and displays those recommended good moves on the screen. The control-means makes it possible for the code to access the screen.

The player who uses this embodiment performs the following steps comprising:
a. Perceiving a challenge to solve. The strategy game shows the current state of the cities on the screen. The player is to improve the growth of cities. This is the challenge.
b. Making an actionable choice towards solving the challenge. The player allocates resources in the game to promote growth of cities.
c. Viewing a feedback on how the actionable choice performs in solving the challenge. The game computes the results of the player's choices and displays them on the screen. This is the feedback on the effectiveness of the player's choices.
d. Writing code to make the challenge easier, or writing code that makes the actionable choice easier or more effective for solving the challenge, or writing code that makes the feedback more effective for solving the challenge. The player writes code that uses heuristics and other AI algorithms to suggest good next moves for the player. This makes the challenge easier because the player gets good recommendations. It makes the choice of player action also easier because good moves are being suggested automatically. The suggestions are appearing on the screen, so the feedback is also more effective.

Making a strategy learning-game based on a strategy non-learning-game involves performing the following steps comprising:
a. selecting a game that is fun to play, such that the game has a challenge-means, a player-action-means, and a feedback-means. We choose a city building strategy game. It has all the required components: challenge-means, player-action-means, and feedback-means.
b. Adding a coding-means to the game. We present the user/player with a code editor.
c. Adding a control-means to the game. We give the entered-code access to the screen of the game.
d. Adding a constraint-means to the game such that the constraint-means ensures that the game remains fun to play after code is entered into the coding-means. We limit the capabilities of the entered code so that it cannot make the game trivially easy to play.
e. Changing the challenge-means so that the challenge-means can be controlled by the control-means, or changing the player-action-means so that the player-action-means can be controlled by the control-means, or changing the feedback-means so that the feedback-means can be controlled by the control-means. We give the entered code access to the screen of the game. That is, the feedback-means has been changed so that the feedback-means can be controlled by the control-means and the entered code is able to display suggestions for the next move on the screen.

### Another Embodiment: A Learning-Game Based on a Detective Adventure Game

In another embodiment we start with a detective adventure game. In the detective adventure game, the player is supposed to analyze clues and solve a crime. According to the game narrative, the criminal character in the game has left traces of a white-collar financial crime in some data files. The clues in this game are in the form of data files. That is, the information that can help the player find the criminal is hidden in data contained within files. The player is expected to analyze the data in the files and uncover the clues which will lead the player to the criminal.

While it is possible for the player to look at the data manually and try to uncover clues, it will be far more productive for the player (who plays the role of a detective in the game) to develop code which analyzes the data automatically. Analyzing the data using custom code can help the player uncover clues quickly and with less effort.

The player is provided with a coding-means to help develop the code that analyzes the data files in the game. In other words, while playing this game, the player is motivated to write code to analyze the data files in the game and uncover clues to help the player solve the crime and win the game. While writing code to analyze data files, the player's coding skills improve. So this is an effective learning-game.

The learning game based on crime-solving described here has the following machine structure comprising:
a. A coding-means for enabling a user to enter a code. A code editor is shown to the player/user to enter code.
b. A constraint-means for limiting the effects of the code entered by the user. The code can analyze the data files in the game. The code shouldn't be allowed to interfere with the operation of the rest of the game.
c. A challenge-means for posing a challenge to be solved to the user. The user is challenged to analyze the data files and discover clues to solve the crime.
d. A player-action-means for processing a choice entered by the user for addressing the challenge. The user has a way to progress in the game by entering the player's deductions as clues are discovered from the data files.
e. A feedback-means for communicating effects of the choice to the user. If the player discovers clues effectively, the game progresses towards solving the crime. Otherwise, the player is informed that their hunt for clues in the data files was not successful.
f. A control-means connecting the coding-means with at least one of the challenge-means, the player-action-means, or the feedback-means. The entered code analyzes data files in the game. The data files are part of the challenge presented in the game. In other words, the control-means connects the coding-means with the challenge-means in the game.

The player who uses this embodiment performs the following steps comprising:
a. Perceiving a challenge to solve. The user or player has to analyze the data files and discover clues to solve the crime.
b. Making an actionable choice towards solving the challenge. After analyzing the data files, the player takes action based on the clues discovered from the data files towards solving the crime.
c. Viewing a feedback on how the actionable choice performs in solving the challenge. The game gives the player feedback as the player makes progress towards solving the crime.
d. Writing code to make the challenge easier, or writing code that makes the actionable choice easier or more effective for solving the challenge, or writing code that makes the feedback more effective for solving the challenge. The player can write code to analyze the data files instead of analyzing them manually. Writing code makes the challenge easier.

Making a detective learning-game based on a detective non-learning-game involves

performing the following steps comprising:
a. Selecting a game that is fun to play, such that the game has a challenge-means, a player-action-means, and a feedback-means. We choose a detective game where the player has to analyze data files to discover clues.
b. Adding a coding-means to the game. The player is given a way to enter code and analyze the data files in the game using that code.
c. Adding a control-means to the game. The code entered by the player is given access to the data files in the game.
d. Adding a constraint-means to the game such that the constraint-means ensures that the game remains fun to play after code is entered into the coding-means. The entered code can read data files. It cannot interfere with the rest of the game. If the code were to interfere with the rest of the game, then the player could write code to give the player complete success in the game without analyzing the data files. That can make the game trivial and boring.
e. Changing the challenge-means so that the challenge-means can be controlled by the control-means, or changing the player-action-means so that the player-action-means can be controlled by the control-means, or changing the feedback-means so that the feedback-means can be controlled by the control-means. The data files in the game are part of the challenge. The control-means is given access to these data files so that code entered by the player can analyze these data files.

### Another Embodiment: A Learning-Game Based on a Competitive Card Game

According to another embodiment, we begin with a two player card game where the game mechanics change according to which cards are in the decks. A notable example of card games where the mechanics are determined by the cards in player decks is “Magic: The Gathering”. Games similar to “Magic: The Gathering” are well known in the art and we assume that the reader is familiar with such games.

In the present embodiment, each player is given a deck of cards. Each player deck has the same number of cards. However each deck can have different cards. The capabilities (or power) of each card can be different, and so it is possible for a player to have a deck of cards that are more powerful than the opponent's deck of cards.

Each player is incentivized to collect cards for the deck which are as powerful as possible. A player with more powerful cards in the deck will have an advantage over an opponent with less powerful cards.

Each player is provided with a coding means where the player can input code that solves some coding problem. Each player's coding-means is connected to a constraint-means that examines the code entered by the player. If the player's code has solved the problem, then the player is rewarded with a new card. The power/capabilities of the reward card depends on how well the player solved the coding problem. The player can add the reward card to their deck. Each card can have rules that over-ride the general rules of the game. So adding a new card to a player's deck is to change the challenge-means, player-action-means, and feedback-means of the game. In other words, by writing code in the coding-means, the player is changing the game-mechanics.

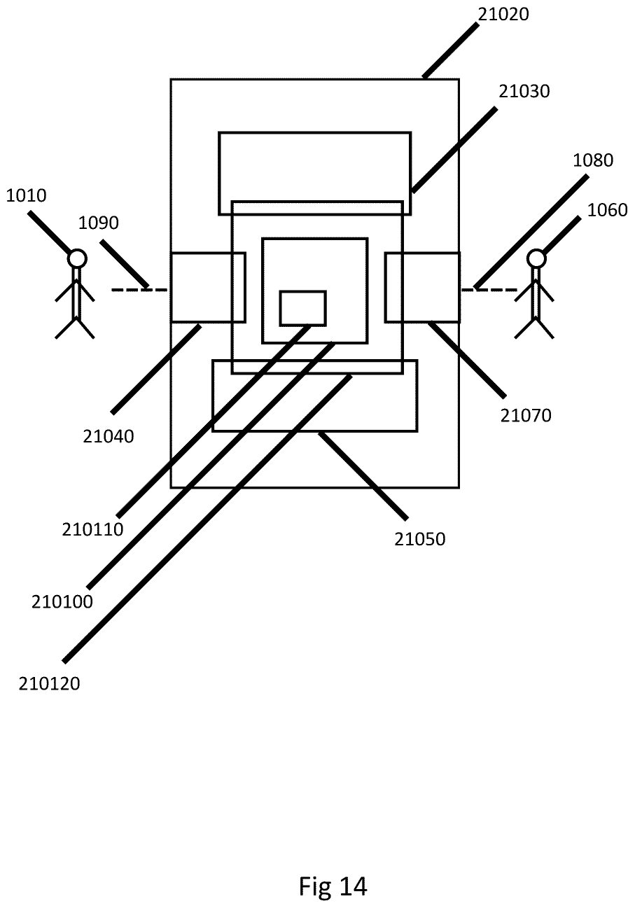

Consider FIG. 14. The card game described above is 21020. 1010 is player1. 1060 is player2. Each of them is given a deck of cards to start with. The deck of cards given to player1 corresponds to how they interact with the game. So the deck that belongs to player1 is 1090, the input-means for player1. Similarly 1080, the deck of cards of player2, is the input-means for player2. When playing the game, player1 brings cards into play on a “battlefield” which is usually a flat surface like a table. The choice of which cards to bring into play is the player1's action in the game. This is 21040, the player1's player-action-means. Similarly, 21070 is the player2's player-action-means.

210100 is the coding-means which each player can use to solve coding problems. 210110 is the constraint-means which examines the code-solutions submitted by each player and rewards each player with cards. 210120 is the control-means. In this embodiment 210120 is the mechanism by which a reward card is printed and cut into a physical card that is then added to the player's deck. The power of the reward cards depends on how well each player's solution-code solves the assigned problem. A good solution will earn a more powerful card as reward.

When a card is added to either player's deck, it changes at least one of the challenge-means 21030, player-action-means 21040, player-action-means 21070, or the feedback-means 21050. In other words, when players enter code into 210100 the coding-means, they are affecting the challenge-means, player-action-means, and feedback-means.

The constraint-means 210110 ensures that players only get the cards they deserve. The power of the reward cards depends on how well players solve coding problems.

So the card game remains fun to play. This is a learning-game because players have to solve coding problems to win against their opponent. In other words, the present embodiment is a fun learning-game.

The learning game based on cards described here has the following machine structure comprising:
a. A coding-means for enabling a user to enter a code. The player or user enters code to solve coding problems.
b. A constraint-means for limiting the effects of the code entered by the user. The code is limited to solving the problem assigned. The constraint-means also ensures that the player is rewarded with cards of appropriate power for the problems solved by the player's code.
c. A challenge-means for posing a challenge to be solved to the user. Each player is challenged to defeat the other player.
d. A player-action-means for processing a choice entered by the user for addressing the challenge. The user chooses a card to play and brings it into play on the “battlefield”. The players then follow the instructions on the card that has been brought into play.
e. A feedback-means 11050 for communicating effects of the choice to the user. The state of the cards on the battlefield is the feedback each player receives about how the game is going.
f. A control-means 110120 connecting the coding-means 110100 with at least one of the challenge-means 11030, the player-action-means 11040, or the feedback-means 11050. The control-means is mechanism by which players print out their reward cards and add them to their deck.

The player who uses this embodiment performs the following steps comprising:
a. Perceiving a challenge to solve. The challenge is to defeat the other player.
b. Making an actionable choice towards solving the challenge. The player chooses which cards to play and when.
c. Viewing a feedback on how the actionable choice performs in solving the challenge. Seeing the state of the cards on the battlefield, the player gets feedback on which player is ahead.
d. Writing code to make the challenge easier, or writing code that makes the actionable choice easier or more effective for solving the challenge, or writing code that makes the feedback more effective for solving the challenge. Writing code to solve problems gets reward cards. These reward cards make the challenge easier. The reward cards also change the possible set of cards which the player can play, that is, they change the player-action-means.

Making a card-based learning-game based on a card-based non-learning-game involves performing the following steps comprising:
a. Selecting a game that is fun to play, such that the game has a challenge-means, a player-action-means, and a feedback-means. We begin with a card game where the game mechanics change according to which cards are in the decks. A notable example of card games where the mechanics are determined by the cards in player decks is “Magic: The Gathering”.
b. Adding a coding-means to the game. We add a way for the player to enter code to solve coding problems and exercises.
c. Adding a control-means to the game. We add a way for players who solve coding problems successfully to be rewarded with cards that they can use in the game.
d. Adding a constraint-means to the game such that the constraint-means ensures that the game remains fun to play after code is entered into the coding-means. We add a way to reward players with cards that is fair. When the player solves a tough coding problem, they get a powerful card as reward. On the other hand, when they solve a simple coding problem, they get a less powerful card. This fairness ensures that the game remains fun to play.
e. Changing the challenge-means so that the challenge-means can be controlled by the control-means, or changing the player-action-means so that the player-action-means can be controlled by the control-means, or changing the feedback-means so that the feedback-means can be controlled by the control-means. We change the rules of the original card game so that each player's reward cards can be used in their respective decks and played onto the “battlefield”. The cards in the decks and in play on the table (aka “battlefield”) are the challenge-means, player-action-means, and the feedback-means. The control-means is the mechanism that prints reward cards and makes them available physically. Changing the game rules to allow reward cards to be used makes it possible for the new cards (created by the control-means) to affect the challenge-means, player-action-means, and the feedback-means.

### Another Embodiment: A Learning-Game Based on a Cooperative Card Game

According to another embodiment, instead of starting with a competitive card game (an example of a competitive game is MTG, Magic: the Gathering), we base our embodiment on cooperative solo/multiplayer card games. Some notable examples of cooperative card games are: “Lord of the Rings, the Card Game” by Fantasy Flight Games, or “Arkham Horror, card game” by Fantasy Flight Games, or “Marvel Champions, card game” by Fantasy Flight Games, or “Dominion” by Donald Vaccarino, published by Rio Grande Games, or “Call to Adventure” by Brotherwise Games.

These games are well-known in the art and we will assume that the reader is familiar with them.

The learning game based on cooperative card games described here has the following machine structure comprising:
a. A coding-means for enabling a user to enter a code. These can be exercises that the player solves by entering code. The exercises may have random elements in them to ensure that each player has to enter code that is different from other player. Random customization for each player will disincentivize copying, cheating, or looking up on the web.
b. A constraint-means for limiting the effects of the code entered by the user. The constraint means verifies that the code entered by the player solves the assigned problem. If the code entered is satisfactory, the player gets reward cards that are appropriate for the problem that was solved. Easy problems get low-power rewards, and solving difficult problems get the player powerful reward cards.
c. A challenge-means for posing a challenge to be solved to the user. A cooperative card game can have an automated or randomized opponent. The automated opponent has to be stopped/defeated for the players to win the game.
d. A player-action-means for processing a choice entered by the user for addressing the challenge. Players/user address the challenge by game mechanics such as drawing cards from decks, playing cards in their hand onto the table, purchasing cards, or discarding cards.
e. A feedback-means for communicating effects of the choice to the user. As the players follow rules and update the game state, they will get to know the progress they make towards defeating the automated opponent.
f. A control-means connecting the coding-means with at least one of the challenge-means, the player-action-means, or the feedback-means. The control-means is the mechanism by which each player prints out their reward cards and adds the reward cards to their decks.

The player who uses this embodiment performs the following steps comprising:
a. Perceiving a challenge to solve. The challenge is to defeat the automated/randomized opponent.
b. Making an actionable choice towards solving the challenge. The player chooses which cards to play and when.
c. Viewing a feedback on how the actionable choice performs in solving the challenge. Seeing the state of the cards on the table, the player gets feedback on progress against the automated opponent.
d. Writing code to make the challenge easier, or writing code that makes the actionable choice easier or more effective for solving the challenge, or writing code that makes the feedback more effective for solving the challenge. Writing code to solve problems gets reward cards. These reward cards make the challenge easier. The reward cards also change the possible set of cards which the player can play, that is, they change the player-action-means.

Making a card-based learning-game based on a card-based non-learning-game involves performing the following steps comprising:
a. Selecting a game that is fun to play, such that the game has a challenge-means, a player-action-means, and a feedback-means. We begin with a cooperative card game where the game mechanics change according to which cards are in the decks.
b. Adding a coding-means to the game. We add a way for the player to enter code to solve coding problems and exercises.
c. Adding a control-means to the game. We add a way for players who solve coding problems successfully to be rewarded with cards that they can use in the game.
d. Adding a constraint-means to the game such that the constraint-means ensures that the game remains fun to play after code is entered into the coding-means. We add a way to reward players with cards that is fair. When the player solves a tough coding problem, they get a powerful card as reward. On the other hand, when they solve a simple coding problem, they get a less powerful card. This fairness ensures that the game remains fun to play.
e. Changing the challenge-means so that the challenge-means can be controlled by the control-means, or changing the player-action-means so that the player-action-means can be controlled by the control-means, or changing the feedback-means so that the feedback-means can be controlled by the control-means. We change the rules of the original card game so that each player's reward cards can be used in their respective decks and played onto the table. The cards in the decks and in play on the table are the challenge-means, player-action-means, and the feedback-means. The control-means is the mechanism that prints reward cards and makes them available physically. Changing the game rules to allow reward cards to be used makes it possible for the new cards (created by the control-means) to affect the challenge-means, player-action-means, and the feedback-means.

### Another Embodiment: A Learning-Game Based on a Table-Top RPG

According to another embodiment consider role playing games. “Pathfinder” and “Dungeons and Dragons” are well-known examples of role playing games. In role playing games, when a player enters into combat with a monster in the game, the Game Master asks the player to check for success of that combat by throwing dice. Similarly, in most role playing games, when a player attempts something challenging or difficult, the game master will check the success of that attempt by throwing dice. The results of the dice are adjusted according to the player character's statistics such as strength and skills.

We add a coding means to a role playing game. The player is invited to solve a coding problem or puzzle. As a reward for a successful solution, the player is given some in-game objects that can help the player do well in the role playing game. In other words, the player solves coding puzzles and makes the challenge-means of the role playing game easier. We also add a constraint-means to ensure that the in-game object that the player gets as a reward is only as powerful as would be appropriate given the difficulty of the coding puzzle that the player solved. We add control-means to connect the coding-means with the challenge-means, player-action-means, and feedback-means of the role-playing-game. This control-means will be the rules that the Game Master uses to incorporate the reward-object into the game.

### Another Embodiment: A Learning-Game Based on a Table-Top RPG Using Decks of Cards Instead of Dice

According to another embodiment, instead of resolving combat in role-playing-games using dice, we resolve combat using cards. For instance, suppose the player-character encounters a dragon in the game. The game-master needs to figure out if the player-character wins against the dragon, or if the dragon wins. Usually, the game-master will figure this out using skill checks and ability scores by throwing dice. Instead of throwing dice, we will use decks of cards. That is, the game-master gets a deck of cards and the player gets another deck of cards. The game-master and the player attempt to defeat each other using card mechanics that are similar to the combat in Magic: The Gathering, or Pokemon Trading Card Game, or other combat card games. If the game-master wins the card-combat then we assume that the dragon wins the encounter. If the player wins the card-combat, then we say that the player-character in the game has defeated the dragon.

Similarly, cards can also be used to determine if the player-character is successful at doing difficult things in the game such as climbing a mountain, out-witting a non-player character etc.

We also have a coding-means which the player can use to enter solutions to coding puzzles. If the player enters correct code, the player is rewarded with cards that can be used to resolve combat in the player's favor. That is, the reward cards make the challenge-means easier. We also have a constraint-means that ensures the power of the reward cards is appropriate for the puzzle solved. A control-means enables the player to print out the reward cards and them to the player's deck. The control-means affects the challenge-means, player-action-means, and the feedback-means in this game.

### Another Embodiment: A Learning-Game Based on a Computerized RPG

According to another embodiment we begin with a computerized role playing game (henceforth called RPG). For the purpose of this discussion, the term RPG includes text based interactive-fiction, point-and-click adventure games, as well as full-motion animated role playing games.

An RPG can be thought of as a simulation of a fictional world. This fictional world that is simulated in an RPG can contain different virtual objects. For instance a fictional world in an RPG can contain a drone which flies over the virtual landscape. This drone might have heuristic algorithms which control how it flies while avoiding virtual flying monsters that are trying to catch it. In other words, we are talking of a simulation of a drone inside an RPG and the algorithms that determine how this drone flies in the virtual world of the RPG. The purpose of this drone in the RPG is to assist the player character within the RPG.

The “player character” is the virtual character in the game that is under the control of the human player who is playing the game.

This RPG has a challenge-means which represents the goal that the player character is supposed to accomplish in the game. The challenge may be complicated by virtual monsters in the game that are trying to stop the player character from accomplishing the goal. The player character is under the control of the human user of the game. The player character is the player-action-means through which the human user controls the events in the RPG. The actions of the player character in the game cause changes in the virtual world which are then displayed to the human user on the computer screen. This screen is the feedback-means by which the player learns of the consequences of the chosen player actions. This game has a keyboard and mouse by which player actions are input.

This game further incorporates a coding means by which the user can enter code. The game also has a control-means by which this code entered by the user is used to change the algorithms which control the drone in the game. There is also a constraint-means which ensures that the entered code does not affect other parts of the simulation. The human-player/user is incentivized to enter code that improves the performance of the drone in the game. A drone that has effective algorithms will be able to assist the player character better and thereby help win the game.

Each human player might have a different style of play while trying to accomplish the game's goals. So the code for the drone has to be customized to suit each human player. Therefore a standard code copied from the web will not be suitable for controlling the drone. The human player has to develop the code to control the drone based on their own style of play. In developing the code, the human player will edit the code multiple times and try out different algorithms. Trying out different algorithms is a good learning experience for the human-player/user. In other words this embodiment is a learning game which is also fun to play.

### Techniques for Better Implementation of Embodiments

In the previously described embodiments it is often necessary to provide information to the user or player.

Information can be provided as a video. But videos are easy to embed only within video games. For learning-games that use some other formats such as physical cards, or ball, or rackets, it is good to have an alternate way of presenting information to learners. Furthermore, videos can be slow at providing information. The person who watches a video can learn only as fast as the video is being narrated. Alternative ways of presenting information, such as documents, can be faster at imparting knowledge.

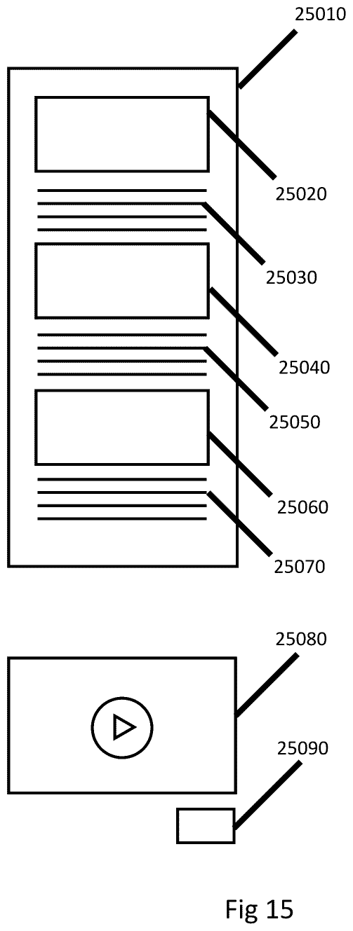

Consider FIG. 15. 25010 is a document. This may be in any document format such as Microsoft Word, HTML (web-page), PDF, EPUB (e-book format) and so on. The document may be displayed on any device or material where pictures and text can be shown, including paper, cloth, e-ink ebook reader devices, tablet computers, laptops, and so on. This document 25010 displays the same information as the video-player 25080. The learner (player or student) can choose to get information either through a video (using 25080) or by reading the document 25010. Both contain equivalent information.

25020 is an image (“still frame”) of the most important or significant frame in the video shown in 25080 within the time period 0 to 10 seconds. The text 25030 is the material (“captions” or “subtext”) that was narrated in the video over that period of 0 to 10 seconds.

The image 25040 is the most important frame in the video within the time period 10 to 18 seconds. The text 25050 is the information that was narrated in the time period 10 to 18 seconds.

The image 25060 is the most important frame in the video within the time period 18 to 30 seconds. The text 25070 is the information that was narrated in the time period 18 to 30 seconds.

The lengths of the time periods will change according to the information in the video. Whenever a significant new frame appears in the video, we create a new time period.

A document 25010 which displays information and frames from a video arranged as described here will be able to convey most of the learning material in the video as a static document containing images and text.

It is possible for a human reader to scan through images and text faster than a viewer can scan through a video. So the document 25010 is more efficient (faster) than the video player 25080 at providing information to a human reader.

Sometimes a reader might wish to slow down and shift from a document to a video. This can be assisted by adding interactive clickable elements to the document. For instance, if the reader were to click the image 25040, then the video player 25080 will be displayed, and the video that corresponds to the document will begin playing at time=10 seconds. The video plays beginning at 10 seconds because the image 25040 represents the information in the video over the time period 10 to 18 seconds.

Similarly, if the reader were to click on the image 25060, the video-player 25080 will seek to 18 seconds and begin playing from that time-point. This is because the image 25060 represents the information in the video over the time period 18 to 30 seconds.

Conversely, a student viewing the video player 25080 might wish to shift to the document view 25010 of the same information. We provide a button 25090 that this student can click to switch over to document-view. If the video is playing at time-point 15 seconds when the student clicks 25090, the document 25010 is opened and scrolled so that 25040 is visible. This is because the image 25040 represents the information in the video over the time period 10 to 18 seconds. The time point 15 seconds is inside the 10 to 18 seconds time-period. 25040 is the corresponding image that should be scrolled into view. Scrolling the appropriate image into view as described here ensures continuity of narrative for the student.

The document format presented here is very efficient at imparting knowledge to learners. It can be displayed as e-books, printed books, and so on.

1. A machine comprising:
a coding-means 110100 for enabling a user to enter a code,
a constraint-means 110110 for limiting the effects of said code entered by said user,
a challenge-means 11030 for posing a challenge to be solved to said user,
a player-action-means 11040 for processing a choice entered by said user for addressing said challenge,
a feedback-means 11050 for communicating effects of said choice to said user,
a control-means 110120 connecting said coding-means 110100 with at least one of said challenge-means 11030, said player-action-means 11040, or said feedback-means 11050,
whereby said machine can be operated as a learning-game that teaches coding skills and is fun to play.

2. A method for learning coding skills comprising:
perceiving a challenge to solve,
making an actionable choice towards solving said challenge,
viewing a feedback on how said actionable choice performs in solving said challenge, writing code to make said challenge easier, or writing code that makes said actionable choice easier or more effective for solving said challenge, or writing code that makes said feedback more effective for solving said challenge,
whereby a person using said method writes code often, thereby improving coding skills of said person.

3. A method for making a learning-game comprising:
selecting a game that is fun to play, such that said game has a challenge-means, a player-action-means, and a feedback-means,
adding a coding-means to said game,
adding a control-means to said game,
adding a constraint-means to said game such that said constraint-means ensures that said game remains fun to play after code is entered into said coding-means,
changing said challenge-means so that said challenge-means can be controlled by said control-means, or changing said player-action-means so that said player-action-means can be controlled by said control-means, or changing said feedback-means so that said feedback-means can be controlled by said control-means,
whereby said game has been changed into a learning-game that teaches coding skills.
